(19) United States
(12) Patent Application Publication
(10) Pub. No.: US 2018/0032829 A1
(43) Pub. Date: Feb. 1, 2018

(54) SYSTEM FOR COLLECTING EVENT DATA, METHOD FOR COLLECTING EVENT DATA, SERVICE SERVER FOR COLLECTING EVENT DATA, AND CAMERA

(71) Applicant: SNU R&DB FOUNDATION, Seoul (KR)

(72) Inventor: Suhwan KIM, Seoul (KR)

(73) Assignee: SNU R&DB FOUNDATION, Seoul (KR)

(21) Appl. No.: 15/535,155

(22) PCT Filed: Dec. 3, 2015
(86) PCT No.: PCT/KR2015/013144

§ 371 Date: Oct. 23, 2017

(30) Foreign Application Priority Data
Dec. 12, 2014 (KR) 10-2014-0178918
May 20, 2015 (KR) 10-2015-0070369

(51) Int. Cl. G06K 9/20; G06K 9/00; H04N 7/025; H04N 5/247

(52) U.S. Cl. CPC G06K 9/209; H04N 5/247; G06K 9/00771; H04N 7/025; G06T 2207/30232; G06T 2207/30168; G06T 2207/30244; G06K 2209/27; H04N 5/23296

(57) ABSTRACT

A system for collecting event data comprises: a plurality of cameras, each of which collects image data and stores the image data on a storage medium, generates data identification information including at least one information from among the group including time information on when the image data was collected, location information on where the image data was collected, and orientation information of a camera, and transmits periodically, or at a specific point of time, the data identification information via a wired or wireless network; and a service server which determines, among the plurality of cameras, at least one target camera storing image data related to a specific event by using the data identification information and event information including the time and location when and where the event has occurred, and receives image data related to the event from the target camera.

### TECHNICAL FIELD

The technology described below relates to a method and system for collecting event data from an apparatus that acquires data related to an event at a location at which the event occurs to check a particular event when the event occurs.

### BACKGROUND ART

The number of information collection devices, such as an internal building security system, an external building security system, a black box of a vehicle, a portable device having a built-in camera, a wearable device including Google Glass, and the like, for acquiring image data are drastically increasing. Further, information collection devices may acquire various kinds of data, such as sound data, in addition to image data.

An information collection device basically stores data collected thereby or transfers the collected data to a server connected thereto via a wired or wireless network. A user checks data which has been separately collected by an information collection device or accesses a server and checks data which has been collected by one or more information collection devices. For example, in the case of an internal building security system, a user checks a past situation by playing image data stored in a storage medium at a later time.

### DISCLOSURE

### Technical Problem

The present invention is directed to providing a method and a system for collecting event data in which only information collection devices store collected data and a central system acquires data related to an event from the information collection devices when the event occurs.

### Technical Solution

One aspect of the present invention provides a system for collecting event data, the system including: a plurality of cameras, each configured to collect and store image data in a storage medium, generate data identification information including at least one piece of information selected from the group consisting of information on a time at which the image data is collected, information on a location at which the image data is collected, and orientation information of the camera, and transmit the data identification information periodically or at a specific time point via a wired or wireless network; and a service server configured to determine at least one target camera storing image data related to a specific event among the plurality of cameras using the data identification information and event information including a time at which the event has occurred and a location at which the event has occurred and receive the image data related to the event from the target camera.

Another aspect of the present invention provides a system for collecting event data, the system including: a plurality of information collection devices, each configured to collect and store data in a storage medium, generate data identification information including at least one piece of information selected from the group consisting of information on a time at which the data is collected, information on a location at which the data is collected, and orientation information of the device collecting the data, and transmit the data identification information periodically or at a specific time point via a wired or wireless network; and a service server configured to receive data related to a specific event from a target information collection device that is at least one information collection device storing the data related to the event among the plurality of information collection devices using the data identification information and event information including a time at which the event has occurred and a location at which the event has occurred.

Another aspect of the present invention provides a method of collecting event data, the method including: collecting, by each of a plurality of information collection devices, image data using a camera and storing the image data and data identification information including at least one piece of information selected from the group consisting of information on a time at which the image data is collected, information on a location at which the image data is collected, and orientation information of the camera; storing, by a service server, the data identification information transmitted via a wired or wireless network; receiving, by the service server, event information including a time at which a specific event has occurred and a location at which the event has occurred; determining, by the service server, a target information collection device that is at least one information collection device storing image data related to the event among the plurality of information collection devices by comparing the event information and the data identification information, and transferring event identification information to the target information collection device; and transmitting, by the target information collection device, event data, which is image data related to the event information, to the service server using the event identification information.

Another aspect of the present invention provides a method of collecting event data, the method including: collecting, by each of a plurality of information collection devices, image data using a camera and storing the image data and data identification information including at least one piece of information selected from the group consisting of information on a time at which the image data is collected, information on a location at which the image data is collected, and orientation information of the camera; storing, by a management server, the data identification information received from the plurality of information collection devices; transmitting, by a service server, event information including a time at which a specific event has occurred and a location at which the event has occurred to the management server; determining, by the management server, a target information collection device that is at least one information collection device storing image data related to the event among the plurality of information collection devices by comparing the event information and the data identification information, and requesting event data, which is image data related to the specific event, from the related information collection device; and transmitting, by the related information collection device, the event data to the service server.

Another aspect of the present invention provides a method of collecting event data, the method including: acquiring, by each of a plurality of information collection devices, image data using a camera and generating data identification information including at least one piece of information selected from the group consisting of information on a time at which the image data is collected, information on a location at which the image data is collected, and orientation information of the camera; storing, by at least one management server, the data identification information and the image data from the plurality of information collection devices; determining, by a service server, a target management server that is a management server storing image data related to a specific event among the at least one management server by comparing the data identification information and event information including a time at which the event has occurred and a location at which the event has occurred, and transferring event identification information to the target management server; and receiving, by the service server, the event data from the target management server.

Another aspect of the present invention provides a method of collecting event data, the method including: collecting, by each of a plurality of information collection devices, image data using a camera and storing the image data and data identification information including at least one piece of information selected from the group consisting of information on a time at which the image data is collected, information on a location at which the image data is collected, and orientation information of the camera; receiving, by a service server, an event data request including event information including a time at which a specific event has occurred and a location at which the event has occurred; broadcasting, by the service server, the event data; and receiving, by the service server, image data related to the event in response to the broadcast.

Another aspect of the present invention provides a system for collecting event data, the system including: at least one management server configured to receive data identification information including at least one piece of information selected from the group consisting of a time at which each of a plurality of information collection devices collects data, a location at which each of the plurality of information collection devices collects the data, and orientation information of each of the information collection devices at a time point at which the data is collected, and the data from a storage medium storing the data identification information, and store the received data identification information and data; and a service server configured to receive event data, which is data related to a specific event, from the at least one management server using event information of the specific event and the data identification information. The storage medium is connected to the plurality of information collection devices and stores the data collected by the plurality of information collection devices and the data identification information generated by the plurality of information collection devices.

A service server for collecting event data determines at least one information collection device storing data related to a specific event among a plurality of information collection devices by comparing data identification information including at least one piece of information selected from the group consisting of a time at which each of the plurality of information collection devices collects data, a location at which each of the plurality of information collection devices collects the data, and orientation information of each of the information collection devices at a time point at which the data is collected with event information including a time at which the event has occurred and a location at which the event has occurred, and receives the related data from the at least one information collection device. The data identification information is generated by the plurality of information collection devices and transferred to the service server in real time.

While generating image data of a predetermined time point, a camera generates data identification information including orientation information of the time point, maps the generated image data and the data identification information to each other, and stores the mapped image data and data identification information.

### Advantageous Effects

According to technology described below, since only information collection devices store data while a central system does not store the data, the central system has a small storage space to maintain. Further, according to the technology described below, since the information collection devices provide only identification information for specifying collected data to a network, a small amount of resources are consumed in a wired or wireless network.

### DESCRIPTION OF DRAWINGS

FIG. 1 is an example of a block diagram of a conventional system for collecting data.

FIG. 2 is an example of a block diagram of a system for collecting event data.

FIG. 3 is an example of a block diagram showing a constitution of an information collection device.

FIG. 4 is an example of an information flow of a method of collecting event data.

FIG. 5 is another example of an information flow of a method of collecting event data.

FIG. 6 is another example of an information flow of a method of collecting event data.

FIG. 7 is an example in which a server reconstructs or processes collected event data.

FIG. 8 is another example of a block diagram of a system for collecting event data.

FIG. 9 is an example of an information flow of a method of collecting event data.

FIG. 10 is another example of an information flow of a method of collecting event data.

FIG. 11 is another example of an information flow of a method of collecting event data.

FIG. 12 is another example of an information flow of a method of collecting event data.

FIG. 13 is an example of a block diagram of a security system for collecting event data.

FIG. 14 is an example of a block diagram of a smart car system for collecting event data.

FIG. 15 is an example of a block diagram of a security system for collecting event data.

FIG. 16 is an example of a block diagram of a smart car system for collecting event data.

FIG. 17 is an example of transmitting data identification information and image data in the smart car system of FIG. 16.

### MODES OF THE INVENTION

The technology described below may be modified in a variety of ways and may have various exemplary embodiments, and specific exemplary embodiments thereof will be shown as examples in the drawings and described in detail. However, it should be noted that the technology described below is not limited to the specific exemplary embodiments, but includes all possible modifications, equivalents, and replacements which fall within the spirit and scope of the technology described below.

Terms such as first, second, A, B, and the like may be used to describe various components, but the components are not limited by the terms. The terms are used only to distinguish one component from other components. For example, a first component may be named a second component, and a second component may be named a first component in a similar way without departing from the scope of the technology described below. The term “and/or” includes a combination or any of a plurality of associated listed items.

Among the terms used in this specification, a singular expression includes a plural expression unless clearly stated otherwise in the context. Terms such as “including” and the like are used only to designate the features, numbers, steps, operations, components, parts, or combinations thereof described in the specification and do not exclude the presence or addition of one or more other features, numbers, steps, operations, components, parts, or combinations thereof.

Prior to describing the drawings in detail, a division of configuration units in the present specification is only made according to the main function of each of the configuration units. In other words, two or more configuration units, which will be described below, may be combined into a single configuration unit, or one configuration unit may be divided into two or more units according to subdivided functions thereof. Each of the configuration units, which will be described below, may additionally perform a part or all functions of other configuration units besides the main function of the configuration unit, and some of main functions taken by each of the configuration units may be exclusively taken and performed by other configuration units. Therefore, the presence of each configuration unit described through the present specification should be functionally interpreted. For this reason, it should be clearly noted that configurations of configuration units of a system 200 for collecting event data, a security system 700 for collecting event data, and a smart car system 800 for collecting event data described below may differ from corresponding drawings within the limits of achieving the purpose of the technology described below.

When a method or an operating method is performed, steps of the method may be performed in a different order from the described order unless a specific order is clearly mentioned in the context. In other words, steps may be performed in the same order as described, performed substantially simultaneously, or performed in a reverse order.

First, the terminology used in the following description will be defined.

An information collection device denotes a device that collects specific data by using a camera, a microphone or various kinds of sensors. The information collection device may be a device that is fixed at a structure and can change a view direction of a camera, such as a closed-circuit television (CCTV), or a device that collects data while moving in a predetermined direction at a predetermined speed, such as a black box attached to a moving vehicle. In a broad sense, the information collection device may be a sensor device that collects information in a sensor network or a machine-to-machine (M2M) network.

The information collection device collects data by using a camera, a sensor or the like. A device that is included in or connected to the information collection device and collects specific data, such as a camera or a sensor, is comprehensively referred to as a data collection means. The information collection device includes a central processing device, a communication module for data communication, and the like in addition to the data collection means.

Information collected by the information collection device is referred to as image data, sound data, and the like by specifying particular data or detailed targets. According to a type of information collection device, data collected thereby may be at least one of the sound data, smell data, vibration data, temperature data, humidity data, illuminance data, wind speed data, and wind direction data.

The information collection device generates and stores time information of a time point at which the data is collected, location information of a location at which the data is collected, and orientation information of the information collection device (the data collection means) at the time point at which the data is collected. These pieces of information correspond to information generated to specify data collected by the information collection device. Information for specifying the data collected by the information collection device is referred to as data identification information.

When the information collection device moves in a predetermined manner or is disposed in a moving object, the data identification information may include a movement speed, a movement direction, a rotation speed, a rotation direction, and the like. Also, the data identification information may include an identifier (ID) of the information collection device, an ID of the collected data, and the like.

An event denotes an incident that occurs at a specific time in a specific space or at a specific location. The event may be defined by elements, such as movement of a specific object, occurrence of a specific sound, emission of specific light, generation of a signal having a specific frequency, arrival of a signal, and the like. For example, the event includes a traffic accident on a road, a traffic situation on the road, movement of people in a building, an internal situation of the building, status of information collected by a sensor device from an Internet of things (IoT) network, and the like.

Specific data collected by the information collection device is used to determine whether an event has occurred. Therefore, the event may be considered to be an incident that occurs near at least one of a plurality of information collection devices.

Event data denotes data related to the event among the pieces of data collected by the information collection device. The event data makes it possible to check a specific event. From the viewpoint of a user who intends to check the event, the event data corresponds to data for reconstructing a specific event later. For example, when the information collection device is a black box installed in a car and the event is a specific vehicle accident, image data, sound data, and the like of the corresponding vehicle accident location are the event data.

A user or a specific device may request the event data to check the specific event. A message for requesting the event data includes information for specifying the event. Information including the event is referred to as event information. The event information may include information, such as a specific time, a specific location, a specific direction, an ID for specifying the event, or the like. The event information is information corresponding to the data identification information generated by the information collection device.

The event information is basically generated by a device that requests specific data collected by the information collection device or an external device, such as a server. In some cases, the information collection device may transmit the event information to a server.

The data identification information generated by the information collection device is used to determine whether the collected data is related to a specific event. A system that provides a service for checking the event may determine whether the information collection device has collected event data by comparing the event information with the data identification information.

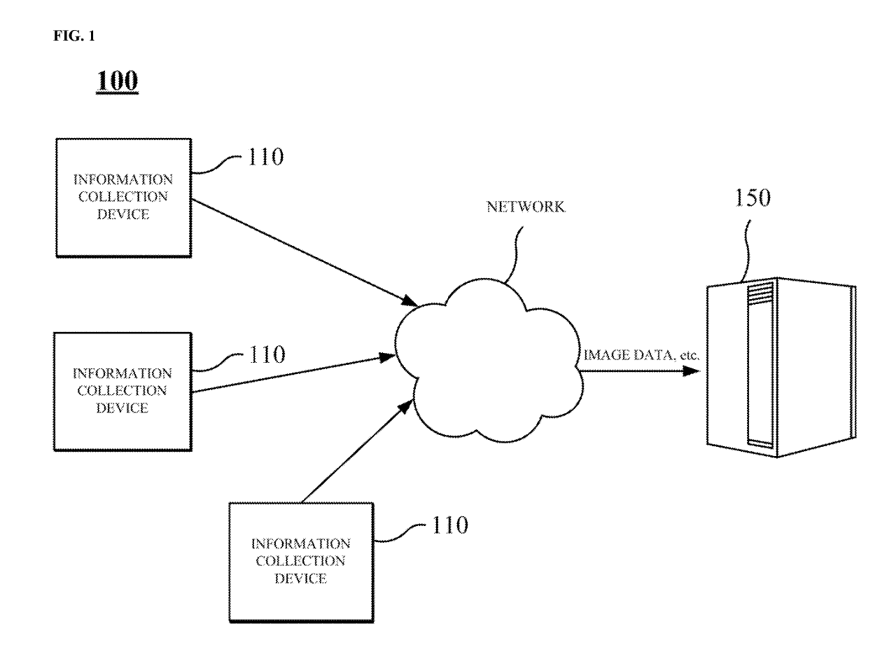

FIG. 1 is an example of a block diagram of a conventional system 100 for collecting data.

The system 100 for collecting data includes a plurality of information collection devices 110 and a service server 150 which receives and stores data collected by the information collection devices 110. The information collection device 110 transfers collected specific data to the service server 150 via a wired or wireless network. For example, in the case of a security system, the camera 110, which corresponds to the information collection device, acquires image data and transfers the acquired image data in real time to the service server 150 via the wired or wireless network. The information collection device 110 may transfer specific data in real time or transfer data stored in a buffer thereof at a later time.

Assuming that the information collection devices 110 of the conventional system 100 for collecting data are disposed over an extensive region and transmit image data to the service server 150, a large amount of data is stored in the service server 150 such that storage space thereof will become insufficient in a short time. In this case, additional cost for expanding the storage space is incurred. For example, when a system for checking a specific event using image data acquired by black boxes of vehicles or camera devices (smart phones) of individuals in an extensive region is commercialized, there is a problem in that the service server 150 should store or process data collected by millions to billions of information collection devices 110. Consequently, the conventional system 100 for collecting data has limitations in storage space and network resources.

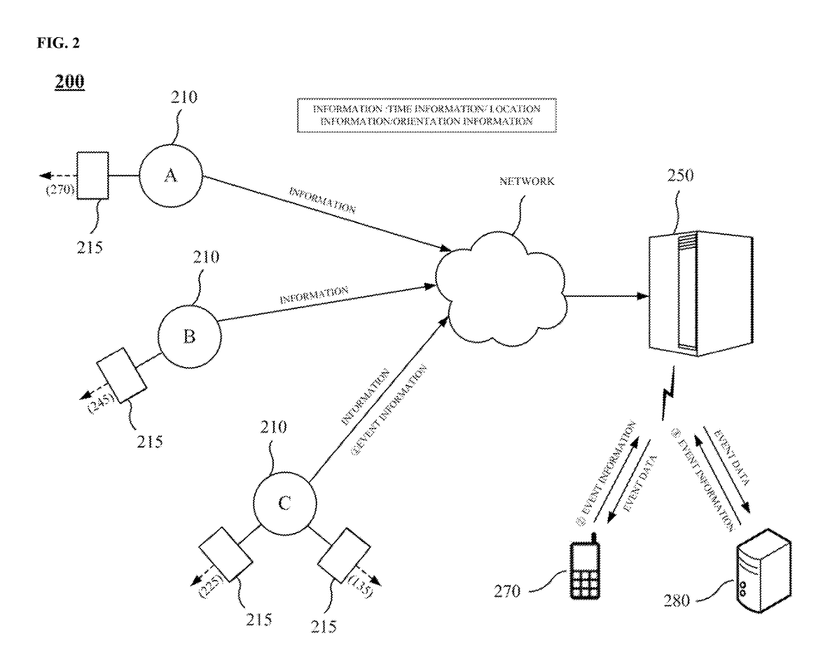

FIG. 2 is an example of a block diagram of a system 200 for collecting event data.

A basic constitution of the system 200 for collecting event data is similar to a basic constitution of the system 100 for collecting event data. The system 200 for collecting event data includes information collection devices 210 which collect specific data and a service server 250. Data or messages collected by the information collection devices 210 are transferred to the service server 250 via a wired or wireless network.

In FIG. 2, the information collection devices 210 include data collection means 215. The data collection means 215 denotes a device which collects specific data thereby. For example, the data collection means 215 denotes a camera, a microphone, or a sensor device which collects various kinds of data. More specifically, the information collection device 210 corresponds to an object including the data collection means 215, a computing device which processes collected data in a predetermined manner, a control device which controls the data collection means 215, a power supply device, and the like. The information collection device 215 basically collects information having directivity. For example, a camera acquires image information of a direction that a lens of the camera faces, and a directional microphone collects different pieces of data according to a direction thereof.

The data collection means 215 is also included in the information collection device of FIG. 1, but is separately shown in FIG. 2 because the information collection device 210 generates and transfers orientation information of the data collection means 215 to the service server 250. The orientation information of the data collection means 215 denotes which direction the data collection means 215 has collected data at a data collection time point on the basis of.

For example, when the data collection means 215 is a camera, a lens direction of the camera may be direction information. Further, in the case of the camera, angle-of-view information corresponding to performance information of the camera may be included in the orientation information. This is because an angle-of-view of the camera determines how wide a region data can be collected in on the basis of a predetermined direction.

Also, when the data collection means 215 is a microphone, a direction of the microphone may be the orientation information. Further, when the data collection means 215 is various kinds of other sensor devices, a reference direction of each of the sensor devices may be the direction information.

Further, the data collection device 210 may transmit information on a time at which the data is collected, information on a location at which the data is collected, and the like in addition to the orientation information to the service server 250. Information on a distance from a location at which a specific event has occurred may be included in the transmission. For example, as the distance information, a distance from a specific object may be measured by analyzing an image or using a distance measurement sensor, such as an ultrasonic sensor, an infrared sensor, or the like.

In FIG. 2, three information collection devices A, B, and C are shown, and orientations of the data collection means 215 of each of the information collection devices 210 are different. Arrows with broken lines on sides of the data collection means 215 indicate directions of the data collection means 215, and numerals shown in parentheses with the broken-line arrows are examples of an azimuth which indicates a direction.

In the system 200 for collecting event data, the information collection means 210 transmits at least one of time information, location information, and orientation information of a time point at which the data collection means 215 has collected specific data to the service server 250. Further, when the information collection means 210 is a moving object, such as a car, a flying object, and a moving robot, or is attached to a moving object, the information collection means 210 may additionally transmit at least one of movement direction information, movement speed information, rotation direction information, and rotation speed information. To specify data collected by the information collection device 210, it is preferable to basically provide the time information and the location information. Further, the orientation information may be important information for specifying image data, sound data, or the like.

The movement speed information or the movement direction information of the moving object may be used to specify data. Also, when the moving object rotates with a predetermined radius, a rotation direction and/or a rotation speed may be used to specify data.

The movement speed information, the movement direction information, and the like may be used to determine whether data collected by a specific information collection means 210 is related to an event even after a predetermined time. For example, if an image related to a specific accident is collected by a camera installed in a car at a first time but the car passes the location of the accident at high speed, data of a second time and thereafter is very likely to be unrelated to the event of the accident.

As a result, data identification information generated for specific data by the information collection means 210 may include at least one of the time information, the location information, the orientation information, the movement speed information, the movement direction information, the rotation speed information, and the rotation direction information.

The information collection means 210 basically stores collected specific data in a storage medium thereof and periodically or sporadically transmits data identification information generated for the specific data to the service server 250. FIG. 2 shows an example in which the information collection device 210 transfers time information, location information, and orientation information among pieces of the data identification information to the service server 250. Since collected specific data varies over time, the information collection means 210 may periodically generate data identification information or generate data identification information every time a location, a direction, or the like is changed. When the information collection means 210 moves, the location information is basically changed. Therefore, the data identification information is preferably generated at predetermined intervals or according to a movement speed.

The service server 250 may receive information indicating that an event has occurred, a message for requesting the event data, or a message for requesting data of a specific time and location. All pieces of information and messages received by the service server 250 include the aforementioned event information even though the pieces of information have different names. FIG. 2 shows an example in which an information collection device 210 C transmits event information, an example in which a user terminal 270 requests the event information, and an example in which a service requesting server 280 requests the event information.

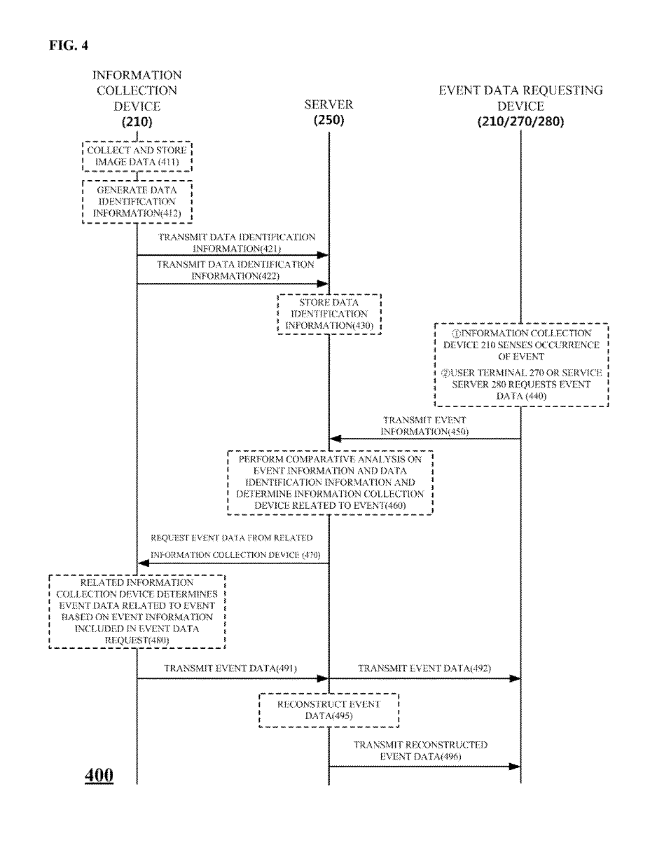

The service server 250 determines the information collection device 210 which has or is highly likely to have data related to the event information by comparing the received event information with the data identification information transmitted by the information collection device 210. Subsequently, the service server 250 receives event data from the corresponding information collection device 210. Further, the service server 250 may transfer the event data to the user terminal 270 or the service requesting server 280 which has requested event data. Various examples of a method of collecting event data will be described below with reference to FIGS. 4 to 6.

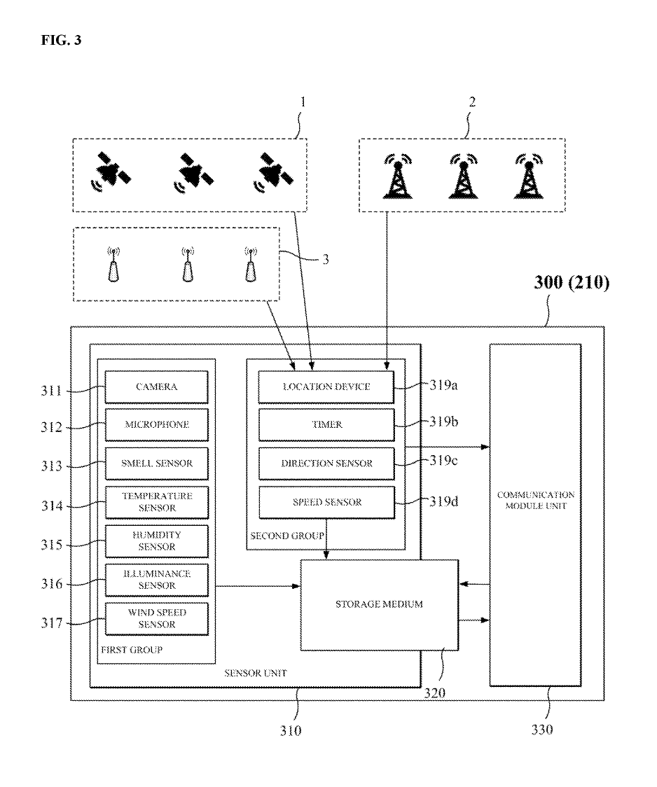

FIG. 3 is an example of a block diagram showing a constitution of an information collection device 300. The information collection device 300 shown in FIG. 3 is the same as the information collection device 210 of FIG. 2. The reference numeral of the information collection device 210 is changed to describe the configuration of the information collection device 300 in FIG. 3.

The information collection device 300 includes a sensor unit 310 which collects specific data and generates data identification information related to the specific data, a storage medium 320 which stores the collected data, and a communication module unit 330 which transmits the data identification information. Although not shown in the drawing, a component, such as a central processing unit (CPU), for collecting data and generating the data identification information may also be necessary.

The sensor unit 310 may be classified into two groups. Sensor devices which are used by the information collection device 300 to collect the specific data are shown on the left side (a first group) of the sensor unit 310 of FIG. 3. Sensor devices which generate the data identification information are shown on the right side (a second group) of the sensor unit 310. The sensor device of the first group correspond to the data collection means 215 of FIG. 2. A camera 311, which collects image data, a microphone 312, which collects sound data, a smell sensor 313, which collects smell data, a temperature sensor 314, which collects temperature data, a humidity sensor 315, which collects humidity data, an illuminance sensor 316, which collects illuminance data, a wind speed sensor 317, which collects wind speed data, and the like may be included in the first group as sensor devices. Data collected by various sensor devices corresponds to event-related information.

The sensor device of the second group which generates the data identification information is a component which generates identification information related to the specific data collected by the sensor devices of the first group. The sensor devices of the second group may include a timer 319b, which generates time information, a location device 319a, for measuring location information of the information collection device 300 or a sensor device which collects data, a direction sensor 319c, which measure orientation and movement direction information, a speed sensor 319d, which measures a movement speed, and the like.

Various sensors may be used as the direction sensor 319c. For example, a magnetic field measurement sensor, a gyroscope, an acceleration sensor, and the like may be used. Alternatively, it is also possible to determine a direction without a direction sensor by analyzing image data.

Further, the direction sensor 319c of the second group may measure a rotation direction, and the speed sensor 319d may measure a rotation speed.

The location device 319a may be a device which uses various systems. Basically, the location device 319a may measure a geographical location using a satellite system 1. In other words, the location device 319a may be a module for using a satellite navigation system, such as a global positioning system (GPS) or a global navigation satellite system (GNSS). Description of a method of measuring a location using signals of three or more satellites will be omitted.

Also, the location device 319a may measure the location using a mobile communication system 2. For example, it is possible to measure the location by triangulation using signals of three or more base stations or by receiving location information of a terminal managed by the mobile communication system 2.

Further, an indoor location system 3 may be used to measure indoor location information. An indoor location technique using wireless fidelity (WiFi) and the like are representative.

Data identification information may be acquired using a variety of other systems or methods other than the aforementioned methods of generating data identification information using the second-group sensor devices.

The storage medium 320 basically stores data collected by the sensor devices 311 to 317 of the first group. Further, the storage medium 320 may store the data identification information corresponding to specific data together with the specific data. It is possible to match the data identification information to the specific data in the form of a table and store the matched data identification information and specific data, or to tag the specific data with the data identification information and store the specific data tagged with the data identification information.

Meanwhile, the communication module unit 330 periodically or sporadically transmits the data identification information generated by the sensor devices of the second group to the service server 250 at a remote place. Further, the communication module unit 330 receives a signal from the service server 250 and transmits the specific data stored in the storage medium 320 to the service server 250.

A method of collecting event data by using the above-described system 200 for collecting event data will be described below. FIGS. 4 to 6 are examples having different procedures. For convenience of description, it is assumed that an information collection device basically collects image data in FIGS. 4 to 6. The reference numerals shown in FIG. 2 will be used as reference numerals of devices.

FIG. 4 is an example of an information flow of a method 400 of collecting event data.

The plurality of information collection devices 210 collect and store image data (411). At the same time, the plurality of information collection devices 210 generate data identification information of the image data (412) and store the data identification information together with the image data.

The information collection devices 210 transfer the generated data identification information to the service server 250 via a wired or wireless network (421 and 422). The information collection devices 210 may periodically transmit the data identification information or may transmit the data identification information when it is determined that an event has occurred by analyzing specific data collected by the information collection devices 210 or using a sensor. The data identification information transmitted by the information collection devices 210 may include an ID for specifying an event corresponding to the data identification information, or may be transmitted together with the ID. For example, if an information collection device is a black box installed in a car, the information collection device may continuously transmit the data identification information at predetermined time intervals, or may transmit the data identification information to the service server 250 when it is determined that a vehicle accident or the like has occurred by analyzing image data collected by the information collection device and/or sound data collected using a microphone. Further, when a vibration sensor, an acceleration sensor, or the like senses a predetermined impact exerted on the car, the car having an accident may transmit the data identification information of the image data collected by the black box.

The service server 250 stores the received data identification information (430). Subsequently, an event data requesting device requests event data (440). As the event data requesting device, a specific information collection device 210 may sense the occurrence of a specific event and request the event data, or the user terminal 270 or the service requesting server 280 may request the event data, as illustrated in FIG. 2. The event data requesting device 210, 270, or 280 transmits event information for specifying an event to the service server 250 (450).

The service server 250 performs a comparative analysis on the received event information and data identification information thereof and determines an information collection device related to the event (460). The event information basically includes event time information and event location information for specifying the event. The service server 250 compares the event time information and the event location information with the data identification information thereof, and determines a piece of data identification information including the same or similar time information and location information. Specifically, the service server 250 compares at least one of time information, location information, orientation information, and the like included in the data identification information with the event information. The service server 250 may determine whether event-related data (event data) collected at a time identical or similar to an occurrence time of an event and a location identical or close to an occurrence location of the event exists and specify at least one information collection device 210 related to the event using identification information of the information collection device 210 included in the data identification information when the event data exists.

The service server 250 requests the event data from the information collection device 210 related to the event (470).

The information collection device 210 which receives the request for the event data determines event data related to the event in specific data stored in the storage medium thereof on the basis of event identification information included in the event data request or transmitted with the event data request (480).

Meanwhile, a user may determine whether the information collection device 210 accepts the event data request transferred from the service server 250 in step 480. Alternatively, the user may set whether his or her information collection device 210 responds to a request for specific event data in advance.

When the event data exists, the information collection device 210 transmits the event data to the service server 250 (491). Subsequently, the service server 250 may transmit the received event data to the user terminal 270 or the service requesting server 280 which has requested the event data (492).

In some cases, the service server 250 may process or reconstruct the received event data in a predetermined manner (495). In particular, when the event data is received from the plurality of information collection devices 210, the event data may be spatially reconstructed on the basis of a location at which the event has occurred or may be reconstructed according to a time flow of the event. The reconstruction of event data will be described below. Subsequently, the service server 250 may transmit the reconstructed event data to the user terminal 270 or the service requesting server 280 which has requested the event data (496).

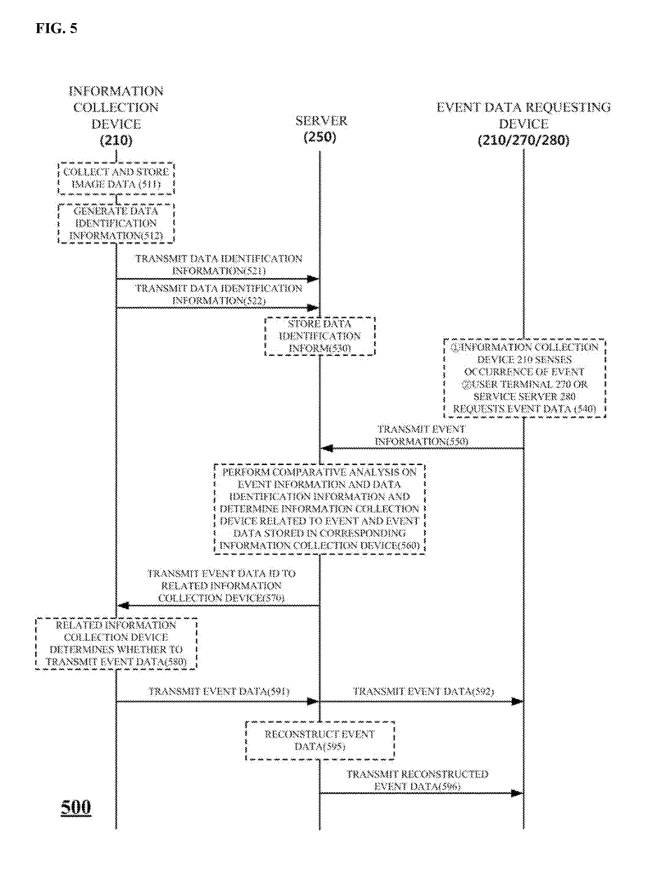

FIG. 5 is another example of an information flow of a method 500 of collecting event data. The method 500 of collecting event data illustrated in FIG. 5 has an overall process similar to that of the method 400 of FIG. 4. Data identification information transmitted by the information collection devices 210 in steps 521 and 522 may include an ID for specifying an event corresponding to the data identification information, or may be transmitted with the ID for specifying the event. The service server 250 which receives event information simultaneously specifies the information collection device 210 related to the corresponding event and determines event data stored in the information collection device 210 (560). Subsequently, the server does not transmit the event information for determining the event data to the information collection device 210 but transmits an event data ID for specifying the event data to the information collection device 210 (570). Subsequently, the information collection device 210 which receives the event data ID determines whether to transmit corresponding specified event data (580) and then transmits event data having the same event ID to the service server 250 (591).

The overall process will be briefly described. The plurality of information collection devices 210 collect and store image data (511). At the same time, the plurality of information collection devices 210 generate data identification information of the image data (512) and store the data identification information together with the image data. In this process, ID information of the collected image data is also stored.

The information collection devices 210 periodically or sporadically transmit the generated data identification information to the service server 250 via a wired or wireless network (512 and 522). As mentioned above, the data identification information may include an ID for specifying an event.

The service server 250 stores the received data identification information (530). Subsequently, the event data requesting device 210, 270, or 280 requests event data (540). As the event data requesting device, a specific information collection device 210 may sense the occurrence of a specific event and request the event data, or the user terminal 270 or the service requesting server 280 may request the event data, as illustrated in FIG. 2. The event data requesting device 210, 270, or 280 transmits event information for specifying an event to the service server 250 (550).

The service server 250 performs a comparative analysis on the received event information and data identification information thereof and determines an information collection device related to the event (560). The service server 250 may determine whether data of an occurrence place of the event (event data) collected at a time identical or similar to an occurrence time of the event and a location identical or close to the occurrence place of the event exists and specify at least one information collection device 210 related to the event using identification information of the information collection device 210 included in the data identification information when the event data exists.

Further, the service server 250 determines an ID of event data related to the event information in the event data transmitted by the specified information collection device 210 using time information, location information, and orientation information (560).

The service server 250 transmits the event data ID to the information collection device 210 related to the event (570). The information collection device 210 which receives the event data ID may determine whether to transmit the event data (580). Alternatively, as mentioned above, a user may set whether to transmit the event data in advance. Step 580 is optional.

The information collection device 210 transmits event data having the event data ID to the service server 250 (591). The service server 250 may transmit the received event data to the user terminal 270 or the service requesting server 280 which has requested the event data (592). In some cases, the service server 250 may process or reconstruct the received event data in a predetermined manner (595). Subsequently, the service server 250 may transmit the reconstructed event data to the user terminal 270 or the service requesting server 280 which has requested the event data (596).

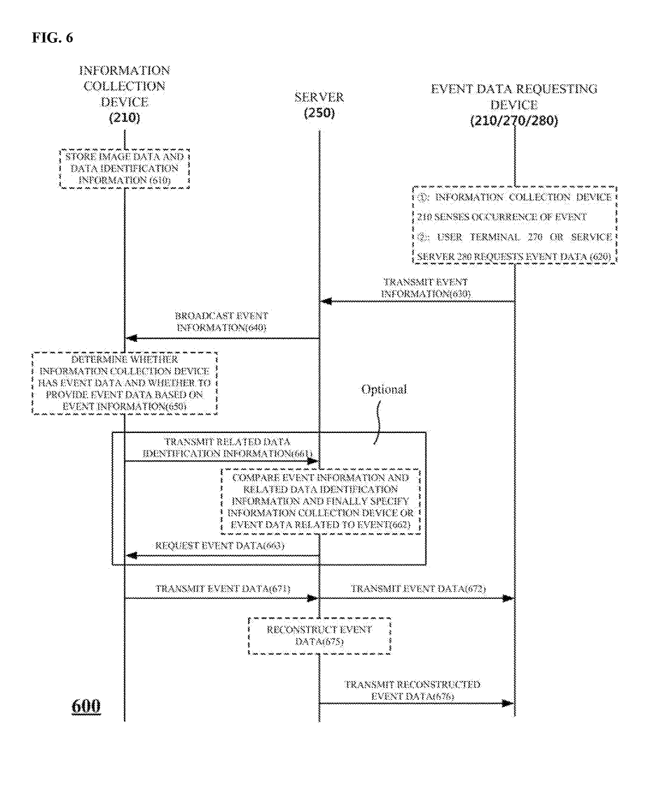

FIG. 6 is another example of an information flow of a method 600 of collecting event data. The plurality of information collection devices 210 collect and store image data, generate data identification information of the image data, and store the data identification information together with the image data (610). In the method 600 of collecting event data illustrated in FIG. 5, the information collection devices 210 do not transmit the data identification information to the service server 250.

Subsequently, the event data requesting device 210, 270, or 280 requests event data (620). As the event data requesting device, a specific information collection device 210 may sense the occurrence of a specific event and request the event data, or the user terminal 270 or the service requesting server 280 may request the event data, as illustrated in FIG. 2. The event data requesting device 210, 270, or 280 transmits event information for specifying an event to the service server 250 (630).

The service server 250 broadcasts the received event information (640).

The information collection device 210 which receives the event information or an event data request determines event data related to the event in specific data stored in the storage medium thereof on the basis of the event information (650). A detailed process is the same as that of the method of FIG. 4 performed by the service server 250 and the information collection device 210.

Subsequently, a procedure indicated by a thick-lined box (“Optional”) in FIG. 6 may be performed, or a procedure 671 in which the information collection device 210 transmits the event data to the server may be directly performed without the procedure.

The optional procedure indicated by the thick-lined box will be described. The information collection device 210 may determine related event data by using the event information and the data identification information thereof in step 650. The information collection device 210 transmits data identification information (related data identification information) of data which is determined to be the event data to the service server 250 (661). The related data identification information denotes data identification information of candidate data which is determined to be the event data. The related data identification information preferably includes an ID of the corresponding data.

The service server 250 finally determines whether the data collected by the information collection device 210 is related to the event by comparing the event information and the related data identification information (662). In other words, a procedure of specifying the event data is repeated by the service server 250.

Subsequently, the service server 250 requests the event data from a finally specified information collection device 210 (663). In this step, the service server 250 may transmit only a finally determined event data ID.

The information collection device 210 transmits the event data to the service server 250 (671). Subsequently, the service server 250 may transmit the received event data to the user terminal 270 or the service requesting server 280 which has requested the event data (672).

In some cases, the service server 250 may process or reconstruct the received event data in a predetermined manner (675). In particular, when event data is received from the plurality of information collection devices 210, the event data may be spatially reconstructed on the basis of a location at which the event has occurred or may be reconstructed according to a time flow of the event. The reconstruction of event data will be described below. Subsequently, the service server 250 may transmit the reconstructed event data to the user terminal 270 or the service requesting server 280 which has requested the event data (676).

Meanwhile, the optional procedure indicated by the thick-lined box in FIG. 6 may be performed in the method 400 of collecting event information illustrated in FIG. 4. For convenience of description, the optional procedure is referred to as a re-verification procedure of a server.

In other words, in FIG. 4, the re-verification procedure of a server may be performed after the information collection device 210 determines the event data (480).

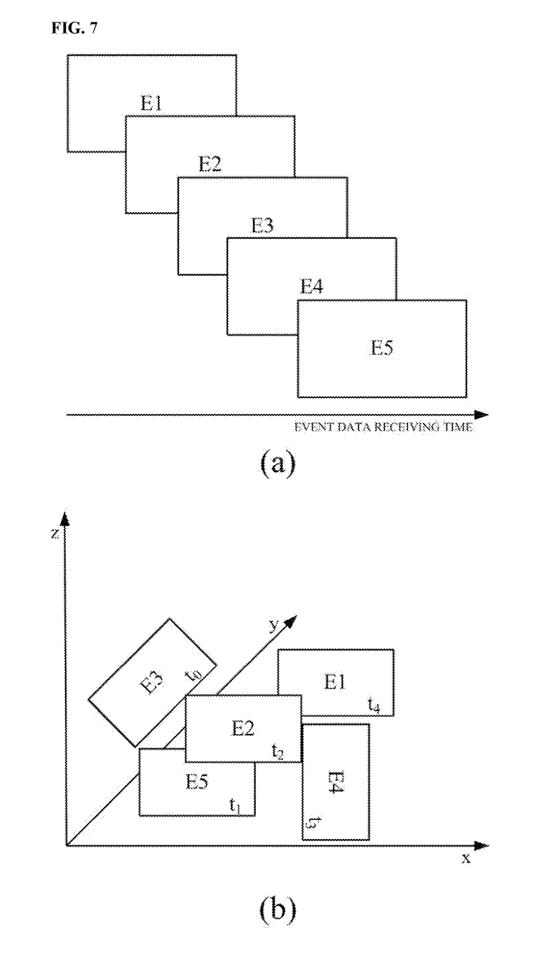

FIG. 7 is an example in which a server reconstructs or processes collected event data. The service server 250 has been described as being able to reconstruct the event data received from the information collection device 210 above.

FIG. 7(A) shows an example in which pieces of event data are received from one or more information collection devices 210. Five pieces of event data E1, E2, E3, E4, and E5 are sequentially transmitted to the service server 250 according to a receiving time thereof.

The service server 250 basically has data identification information corresponding to event data which has already been transmitted. According to the method 500 of collecting data illustrated in FIG. 5, the information collection device 210 preferably transmits event data with related data identification information. The data identification information includes time information, location information, orientation information, and the like of a corresponding event.

Basically, the service server 250 may align the five pieces of received event data on a time axis. In other words, the service server 250 may reconstruct the pieces of event data according to a time flow thereof. FIG. 7(B) shows a state in which the pieces of event data are reconstructed in chronological order of occurrence (t0->t1->t2->t3->t4) unlike an order of reception.

Further, the service server 250 may reconstruct the pieces of event data on a spatial axis according to locations and/or directions of the pieces of event data. FIG. 7(B) shows an example in which the pieces of event data are reconstructed in a three dimensional xyz space.

The service server 250 may reconstruct the event data on the time axis and/or the spatial axis. For example, pieces of image data are arranged according to a time flow thereof and re-encoded on the basis of a specific time point so that a three dimensional image may be generated. Alternatively, the service server 250 may simply sequentially arrange images in a predetermined direction. When the event data is sound data, spatial signal processing may be performed so that a plurality of sounds are heard as sounds actually heard at one spot.

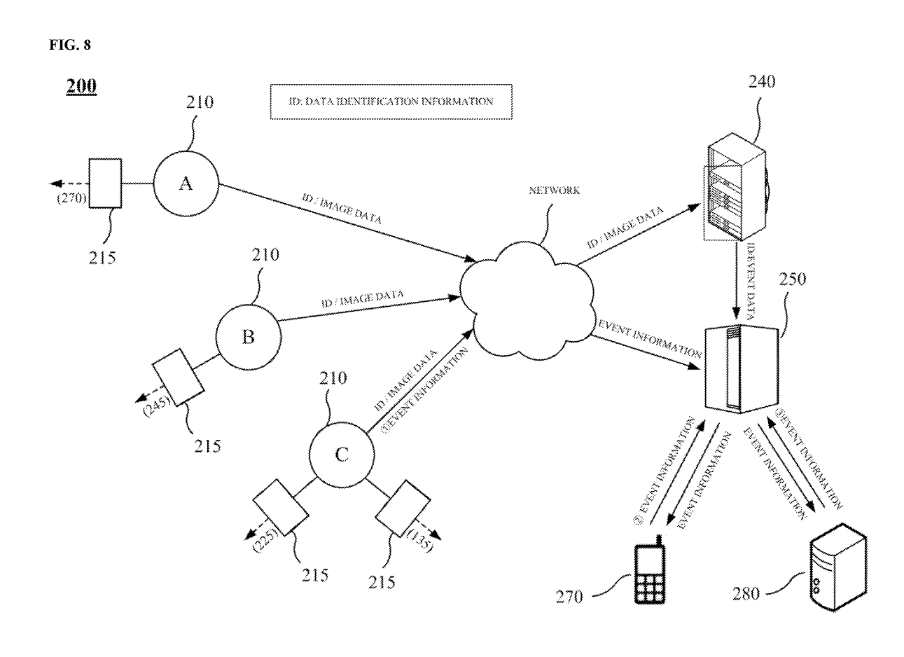

FIG. 8 is another example of the block diagram of the system 200 for collecting event data. FIG. 8 is an example in which a management server 240 is added to FIG. 2.

The system 200 for collecting event data includes the information collection devices 210 which collect specific data and generate data identification information, the management server 240 which stores the data identification information, and the service server 250 which requests and collects event data. Data or messages collected by the information collection device 210 is transferred to the management server 240 and the service server 250 via a wired or wireless network. The management server 240 and the service server 250 may compare event information and data identification information and determine whether specific data is related to an event. In other words, the management server 240 or the service server 250 may determine whether the information collection device 210 which has collected event data related to a specific event exists.

In the system 200 for collecting event data, various components may compare data identification information and event information and determine whether specific data is event data. Various embodiments will be described below. However, for convenience of description, it is assumed that the management server 240 compares the data identification information and the event information and determines whether the event data has been collected.

In FIG. 8, each of the information collection devices 210 includes the data collection means 215. The data collection means 215 denotes a sensor device which collects specific data thereby. For example, the data collection means 215 denotes a camera, a microphone, or a sensor device which collects various kinds of data. The information collection device 210 basically collects direction information having directivity. Orientation information denotes which direction the data collection means 215 has collected data at a data collection time point on the basis of. For example, while collecting specific data, the information collection device 210 generates the orientation information, such as a direction of a camera lens, a direction of a directional microphone, and the like. Further, the orientation information may include angle-of-view information corresponding to performance information of a camera. This is because the angle-of-view of the camera determines how wide a region data can be collected in on the basis of a predetermined direction. Moreover, when the data collection means 215 is various kinds of other sensor devices, a reference direction of each of the sensor devices may be the orientation information. The orientation information is determined on the basis of the data collection means 215.

The data identification information generated by the information collection device 210 may include information on a time at which data is collected, information on a location at which the data is collected, orientation information at a time point at which the data is collected, information on a distance from a spot at which a specific event has occurred, and the like. The distance information denotes a distance between a specific object and the information collection device 210 measured by image analysis or using a distance measurement sensor (an ultrasonic sensor, an infrared sensor, or the like).

In FIG. 8, the three information collection devices A, B, and C are shown, and data collection means 215 of each of the information collection devices 210 face different directions. Arrows with broken lines on sides of the data collection means 215 indicate directions of the data collection means 215, and numerals shown in parentheses with the broken-line arrows are examples of an azimuth which indicates a direction.

The information collection means 210 transmits data identification information of a time point at which the data collection means 215 has collected specific data to the management server 240 via the network. When the information collection means 210 is a moving object, such as a car, a flying object, and a moving robot, or is attached to a moving object, the information collection means 210 may further include at least one of movement direction information, movement speed information, rotation direction information, and rotation speed information in the data identification information.

It is preferable to basically provide time information, location information, and orientation information to specify data collected by the information collection device 210. Further, the movement speed information, the movement direction information, the rotation speed information, or the rotation direction information of the information collection device may also be used to specify the data.

Data identification information generated for specific data by the information collection means 210 may include at least one of the time information, the location information, the orientation information, the movement speed information, the movement direction information, the rotation speed information, and the rotation direction information.

The information collection means 210 basically stores specific data collected thereby in a storage medium thereof and transfers data identification information generated for the specific data to the management server 240. The information collection means 210 may transfer the data identification information to the management server 240 in real time or may transfer the data identification information to the management server 240 at predetermined periods or sporadically.

Since the collected specific data varies over time, the information collection means 210 may generate the data identification information in real time according to a time flow thereof or generate the data identification information at specific periods. Further, the information collection means 210 may generate the data identification information every time a location, a direction, or the like is changed. When the information collection means 210 moves, the location information is basically changed. Therefore, the data identification information is preferably generated at predetermined intervals or at time intervals according to a movement speed.

The service server 250 receives an event data request message for requesting event data. A predetermined service requesting device transmits the event data request message. For example, the user terminal 270 which intends to check event data, the service requesting server 280 which intends to check the event data, and even the information collection device 210 may request the event data. FIG. 8 shows an example in which the information collection device 210 C transmits event information, an example in which the user terminal 270 requests the event information, and an example in which the service requesting server 280 requests the event information. The event request message may be transmitted to the service server via the network of FIG. 8 or a separate network.

The service server 250 transmits event information included in a service request message to the management server 240. The management server 240 determines the information collection device 210 which has or is very likely to have data related to the received event information by comparing the event information with the data identification information transmitted by the information collection device 210. The information collection device 210 having the event data is referred to as a target information collection device, and the information collection device 210 which is very likely to have event data is referred to as a candidate information collection device.

The management server 240 transmits the event data request message to the target information collection device or the candidate information collection device. Subsequently, the service server 250 receives event data from the target information collection device or the candidate information collection device. The service server 250 may transfer the event data to the service requesting device which has requested the event data.

Meanwhile, the information collection devices 210 may transmit image data as well as data identification information to the management server 240 via the wired or wireless network. In this case, the service server 250 may compare the data identification information and the event information and receive the event data directly from the management server 240.

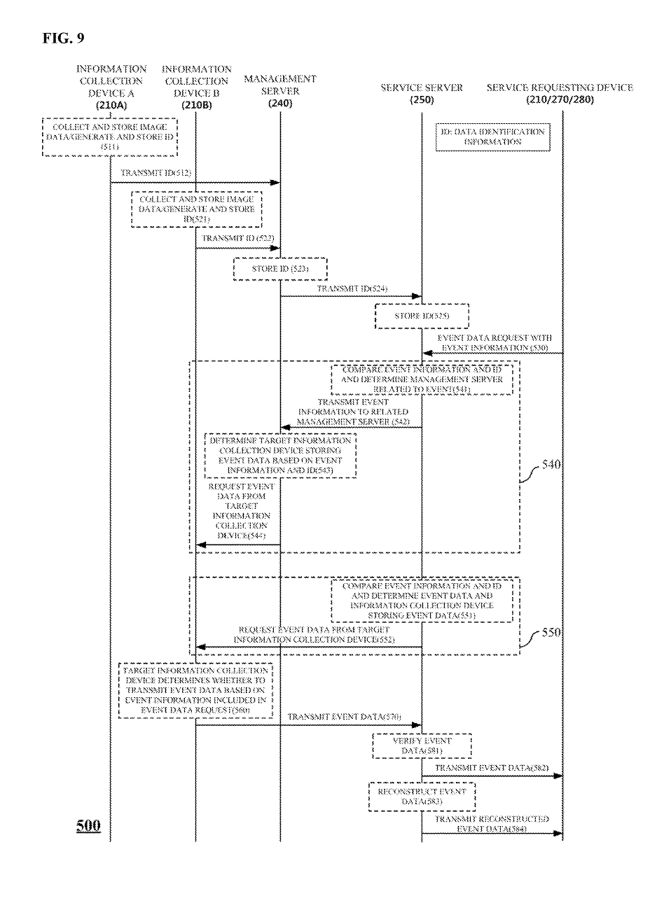

A method of collecting event data by using the system 200 for collecting event data illustrated in FIG. 8 will be described below. FIGS. 9 to 12 are examples having different procedures. For convenience of description, it is assumed that an information collection device basically collects image data in FIGS. 9 to 12. The reference numerals shown in FIG. 8 will be used as reference numerals of devices. Components being indicated with A and B denote that two devices perform the same function.

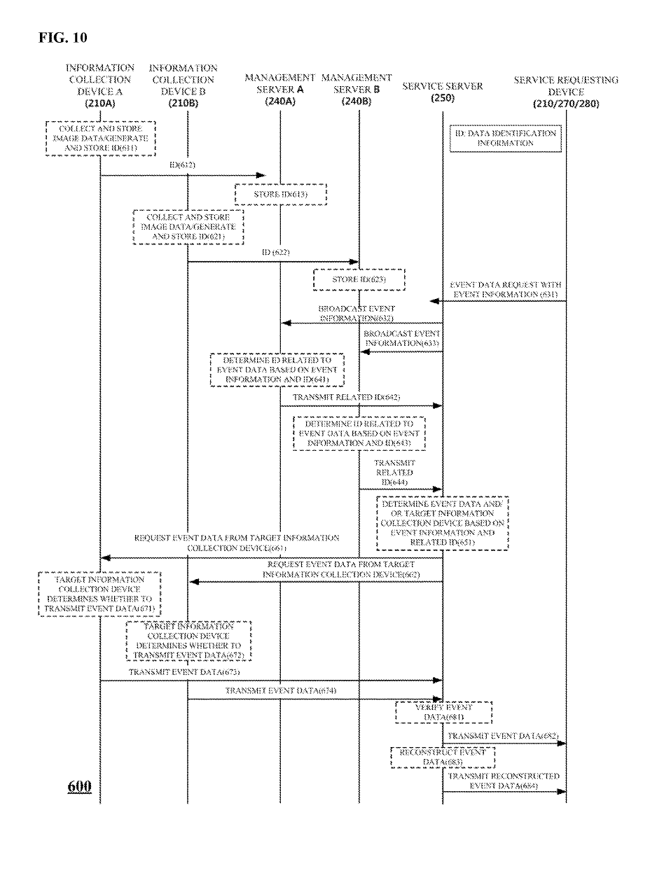

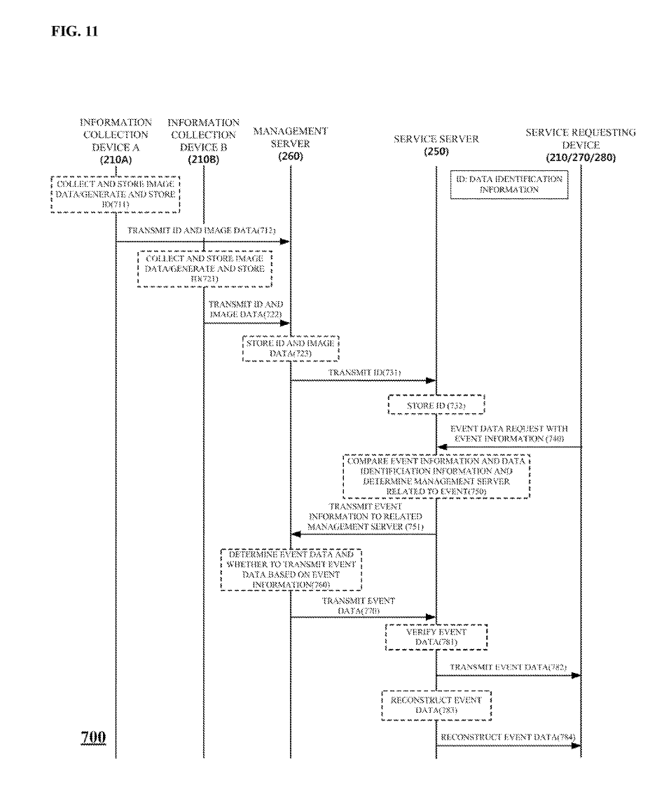

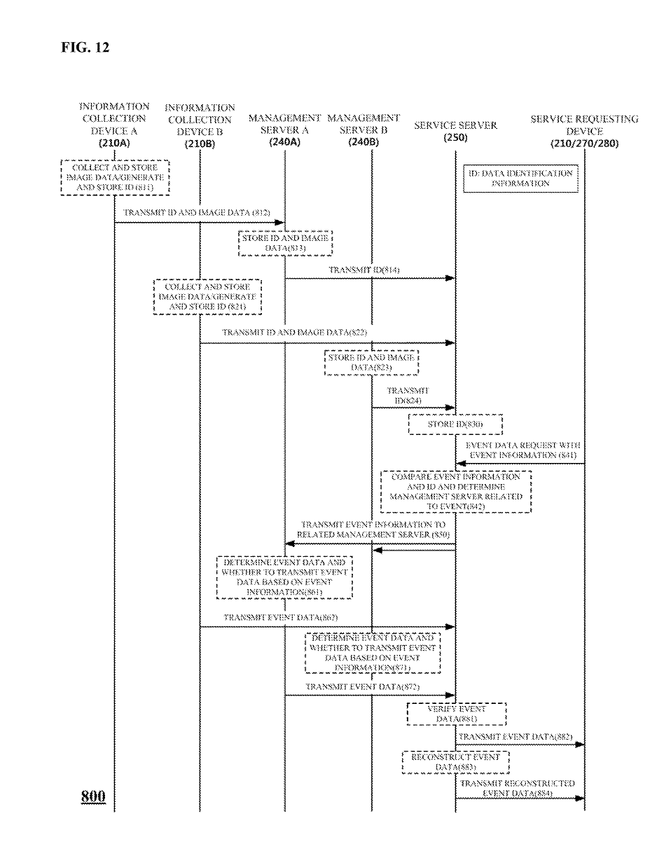

FIGS. 9 and 10 illustrate cases in which the management server 240 receives only data identification information from the information collection device 210 and manages the information collection device 210. FIGS. 11 and 12 illustrate cases in which the management server 240 receives the data identification information and image data from the information collection device 210 and manages the information collection device 210.

FIG. 9 is an example of the information flow of the method 500 of collecting event data. An event data system generally manages a large number of information collection devices. However, FIG. 9 shows an information collection device A 210A and an information collection device B 210B as examples.

The information collection device A 210A collects and stores image data (511). At the same time, the information collection device A 210A generates and stores data identification information of the image data (511). The information collection device A 210A transfers the generated data identification information to the management server 240 via a wired or wireless network (512).

The information collection device B 210B also collects and stores image data and generates and stores data identification information (521). The information collection device B 210B transfers the generated data identification information to the management server 240 via the wired or wireless network (522).

The information collection devices 210A and 210B may transmit the data identification information to the management server 240 periodically or in real time as soon as the image data is generated. Further, the information collection devices 210A and 210B may transmit the data identification information when it is determined that an event has occurred by analyzing collected specific data or using a sensor. For example, if the information collection device is a black box installed in a vehicle, the information collection device may continuously transmit the data identification information at predetermined time intervals, or may transmit the data identification information to the service server 250 when it is determined that a vehicle accident has occurred by analyzing image data collected thereby and/or sound data collected with microphones. The information collection device may sense whether an event, such as a vehicle accident, has occurred using a vibration sensor or an acceleration sensor.

The management server 240 stores the received data identification information (523). The management server 240 transmits the data identification information to the service server 250 (524). The service server 250 stores the received data identification information (525). FIG. 9 shows the single management server 240 only, but the service server 250 may receive data identification information from a plurality of management servers and store the received data identification information.

Subsequently, the service requesting device 210, 270, or 280 transmits an event data request message including event information to the service server 250 (530). The specific information collection device 210 which senses the occurrence of a specific event, the user terminal 270, or the service requesting server 280 may request the event data.

A process in which the service server 250 requests the event data from a target information collection device may be varied. For example, FIG. 9 shows two processes through which the service server 250 requests the event data (steps 540 and 550).

First, step 540 will be described. The service server 250 may compare the event information received from the service requesting device and data identification information stored therein and determine a management server related to an event (541). The service server 250 determines the management server 240 which has received the data identification information from the target information collection device having the event data. This step is important when a plurality of management servers exists. When only the single management server 240 exists, a management server related to the event is not determined, and the event information is directly transmitted to the management server.

The service server 250 transmits the event information to the management server related to the event (542). The management server 240 compares the received event information and the data identification information and determines a target information collection device related to the event between the information collection devices which have transmitted the data identification information thereto (543). In FIG. 9, the information collection device B 210B is assumed to be the target information collection device. The management server 240 requests event data from the target information collection device 210B (544). The management server 240 transmits an event data request including the event information to the information collection device.

Step 550 will be described. The service server 250 which receives the event data request (530) compares the event information and the data identification information thereof and determines an information collection device storing event data and/or the event data (551). Since the target information collection device has been determined, the service server 250 may request the event data directly from the target information collection device 210B and not through the management server 240 (552).

The event information basically includes event time information and event location information for specifying the event. To determine an event-related management server, the target information collection device, or the event data, the management server 240 compares the event information and the data identification information thereof and determines a piece of data identification information including time information and location information which are identical or similar to the event information. Specifically, the management server 240 compares time information included in the data identification information and the event time information and compares location information and orientation information included in the data identification information and the event location information. Further, the management server 240 may also use movement direction information, movement speed information, rotation speed information, rotation direction information, distance information, and the like included in the data identification information to determine the target information collection device.

Basically, the management server 240 determines whether event-related data (event data) collected at a time identical or similar to an occurrence time of the event and a location identical or close to an occurrence location of the event exist. When the event data exists, the management server 240 may specify the information collection device B 210B related to the event using the data identification information or identification information of the information collection device 210 included in the data identification information.

The information collection device B 210B which receives the event data request determines the event data in specific data stored in the storage medium thereof on the basis of the event identification information (an ID) included in the event data request or transmitted with the event data request (560). Further, when the information collection device B 210B receives the event information, the information collection device B 210B may compare the event information and the data identification information thereof and determine the event data (560). In this case, a determination of the event data may be made by the management server 240 and the information collection device 210 twice.

Meanwhile, the information collection device B 210B may determine whether to accept the event data request (560). A user of the information collection device B 210B may set whether to respond to a specific event data request in advance or may determine whether to respond when the event request message is received.

The information collection device B 210B transmits the event data to the service server 250 (570). In FIG. 9, the information collection device 210 transmits event data directly to the service server 250 via the network. However, in some cases, the information collection device 210 may transfer event data to the service server 250 through the management server 240. For example, this is a case in which the management server 240 is a relay controlling a plurality of information collection devices or a gateway controlling access to another network.

The management server 240 may be a server which provides a specific service, a database which manages specific data, or a relay or gateway device which manages the transfer of the specific data.

Subsequently, the service server 250 may transfer the received event data to the service requesting device which has requested the event data (582). Meanwhile, before the event data is transmitted to the service requesting device, the service server 250 may verify whether the received event data corresponds to the event information (581). Although not shown in the drawing, the service server 250 should receive data identification information of the event data from the information collection device B 210B or the management server 240 to verify the event data. The service server 250 may compare the data identification information and the event information again and determine whether the event data is valid data (581). Step 581 is not a necessary step but is an optional step.

In some cases, the service server 250 may process or reconstruct the received event data in a predetermined manner (583). In particular, when event data is received from the plurality of information collection devices 210, the event data may be spatially reconstructed on the basis of a location at which the event has occurred or may be reconstructed according to a time flow of the event. The reconstruction of event data will be described below. Subsequently, the service server 250 may transmit the reconstructed event data to the service requesting device which has requested the event data (584). Step 583 is not a necessary step but is an optional step.

FIG. 10 is another example of the information flow of the method 600 of collecting event data. Unlike FIG. 9, FIG. 10 corresponds to a case in which two management servers 240A and 240B exist.

The information collection device A 210A collects and stores image data (611). At the same time, the information collection device A 210A generates and stores data identification information of the image data (611). The information collection device A 210A transfers the generated data identification information to the management server 240 via a wired or wireless network (612). The management server A 240A stores the data identification information transferred thereto by the information collection device A 210A (613). The management server A 240A is a device which manages data of the information collection device A 210A.

The information collection device B 210B also collects and stores image data and generates and stores data identification information (621). The information collection device B 210B transfers the generated data identification information to the management server B 240B via the wired or wireless network (622). The management server B 240B stores the data identification information received from the information collection device B 210B (623). The management server B 240B is a device which manages data of the information collection device B 210B.

Subsequently, the service requesting device 210, 270, or 280 transmits an event data request message including event information to the service server 250 (631).

The service server 250 broadcasts the event information to the management server A 240A and the management server B 240B which separately manage different information collection devices (632 and 633). The service server 250 does not transmit the event information to a specific management server but broadcasts the event information to the management server 240 which can receive a signal.

The management server A 240A which receives the event information performs a comparative analysis on the event information and data identification information thereof and determines data identification information related to event data (641). The management server A 240A transmits the data identification information determined to be related to the service server 250 (642).

The management server B 240B also determines data identification information related to the event data by performing a comparative analysis on the event information and data identification information thereof (643), and transmits the related data identification information to the service server 250 (644).

The service server 250 compares the event information and the related data identification information and determines event data (an ID of the event data) and/or a target information collection device having the event data (651). In FIG. 10, it is assumed that both the information collection device A 210A and the information collection device B 210B are target information collection devices.

The service server 250 transmits an event data request including the event information or event data identification information to the information collection device A 210A (661). Also, the service server 250 transmits the event data request including the event information or event data identification information to the information collection device B 210B (662).

FIG. 10 shows that the service server 250 requests the event data from the target information collection device thereby, but the service server 250 may request event data from the target information collection device through the management server 240 like in step 540 of FIG. 9.

The information collection device A 210A which receives the event data request determines event data related to the event in specific data stored in the storage medium thereof on the basis of the event data identification information included in the event data request or transmitted with the event data request (671). The information collection device B 210B also determines the event data on the basis of an event data identification number (672). When the information collection devices 210A and 210B receive the event information, the information collection device 210A and 210B may compare the event information and the data identification information thereof and determine the event data.

Meanwhile, the information collection device A 210A may determine whether to accept the event data request (671). The information collection device B 210B may also determine whether to accept the event data request (672).

The information collection device A 210A transmits the event data to the service server 250 (673). The information collection device B 210B also transmits the event data to the service server 250 (674).

Subsequently, the service server 250 may transmit the received event data to the service requesting device which has requested the event data (682). Meanwhile, before the event data is transmitted to the service requesting device, the service server 250 may verify whether the received event data corresponds to the event information (681).

In some cases, the service server 250 may process or reconstruct the received event data in a predetermined manner (683). In particular, when the event data is received from the plurality of information collection devices 210, the event data may be spatially reconstructed on the basis of a location at which the event has occurred or may be reconstructed according to a time flow of the event. The reconstruction of event data will be described below. Subsequently, the service server 250 may transmit the reconstructed event data to the service requesting device which has requested the event data (684).

FIG. 11 is another example of an information flow of a method 700 of collecting event data. FIG. 11 shows an example in which the information collection devices 210A and 210B transmit data identification information and image data to the management server 240 and the management server 240 stores and manages the image data as well as the data identification information.

The information collection device A 210A collects and stores image data (711). At the same time, the information collection device A 210A generates and stores data identification information of the image data (711). The information collection device A 210A transfers the generated data identification information and the image data to the management server 240 via a wired or wireless network (712). The information collection device B 210B also collects and stores image data and generates and stores data identification information (721). The information collection device B 210B transfers the generated data identification information and the image data to the management server 240 via the wired or wireless network (722).

The management server 240 stores the data identification information and the image data received from the information collection devices 210A and 210B (723). The management server 240 transmits the data identification information to the service server 250 (731). The service server 250 stores the received data identification information (732). FIG. 11 only shows the single management server 240, but the service server 250 may receive data identification information from a plurality of management servers and store the received data identification information.

Subsequently, the service requesting device 210, 270, or 280 transmits an event data request message including event information to the service server 250 (740).

The service server 250 may compare the event information received from the service requesting device and data identification information stored therein and determine a management server related to an event (750). This step is important when a plurality of management servers exist. When only the single management server 240 exists, a management server related to the event is not determined, and the event information is directly transmitted to the management server.

The service server 250 transmits the event information (an event data request) to the management server related to the event (751). The management server 240 compares the received event information and the data identification information and determines event data in image data thereof (760). Meanwhile, the management server 240 may determine whether to accept the event data request. A setting of whether to accept the event data request may be included in the data identification information transferred by the information collection devices 210.

The management server 240 transmits the determined event data to the service server 250 (770).

Subsequently, the service server 250 may transmit the received event data to the service requesting device which has requested the event data (782). Meanwhile, before the event data is transmitted to the service requesting device, the service server 250 may verify whether the received event data corresponds to the event information (781).

In some cases, the service server 250 may process or reconstruct the received event data in a predetermined manner (783). In particular, when the event data is received from the plurality of information collection devices 210, the event data may be spatially reconstructed on the basis of a location at which the event has occurred or may be reconstructed according to a time flow of the event. Subsequently, the service server 250 may transmit the reconstructed event data to the service requesting device which has requested the event data (784).

FIG. 12 is another example of information flow of a method 800 of collecting event data. FIG. 12 shows a case in which the plurality of management servers 240 exist and the management servers 240 manage data identification information and image data. In FIG. 12, the management server A 240A and the management server B 240B are shown as an example.

The information collection device A 210A collects and stores image data (811). At the same time, the information collection device A 210A generates and stores data identification information of the image data (811). The information collection device A 210A transfers the generated data identification information and the image data to the management server 240 via a wired or wireless network (812). The management server 240 stores the received data identification information and image data (813). The management server 240 transmits the received or stored data identification information to the service server 250 (814).

The information collection device B 210B also collects and stores image data and generates and stores data identification information of the collected data (821). The information collection device B 210B transfers the generated data identification information and the image data to the management server 240 via the wired or wireless network (822). The management server 240 stores the received data identification information and image data (823). The management server 240 transmits the received or stored data identification information to the service server 250 (824).

The service server 250 stores the received data identification information (830). Subsequently, the service requesting device 210, 270, or 280 transmits an event data request message including event information to the service server 250 (841).

The service server 250 may compare the event information received from the service requesting device and data identification information stored therein and determine a management server related to an event (842). This step is important when the plurality of management servers exist. When only one management server 240 exists, a management server related to the event is not determined, and the event information is directly transmitted to the management server.

The service server 250 transmits the event information (an event data request) to the management server related to the event (850). In FIG. 12, it is assumed that both the management server A 240A and the management server B 240B are target information collection devices.

The management server A 240A compares the received event information and the data identification information and determines event data in the image data thereof (861). Meanwhile, the management server A 240A may determine whether to accept the event data request. A setting of whether to accept the event data request may be included in the data identification information transferred by the information collection device 210. The management server A 240A transmits the determined event data to the service server 250 (862).

The management server B 240B compares the received event information and the data identification information and determines event data in the image data thereof (871). Meanwhile, the management server B 240B may determine whether to accept the event data request. The management server B 240B transmits the determined event data to the service server 250 (872).

Subsequently, the service server 250 may transmit the received event data to the service requesting device which has requested the event data (882). Meanwhile, before the event data is transmitted to the service requesting device, the service server 250 may verify whether the received event data corresponds to the event information (881).

In some cases, the service server 250 may process or reconstruct the received event data in a predetermined manner (883). In particular, when the event data is received from the plurality of information collection devices 210, the event data may be spatially reconstructed on the basis of a location at which the event has occurred or may be reconstructed according to a time flow of the event. The reconstruction of event data will be described below. Subsequently, the service server 250 may transmit the reconstructed event data to the service requesting device which has requested the event data (884).

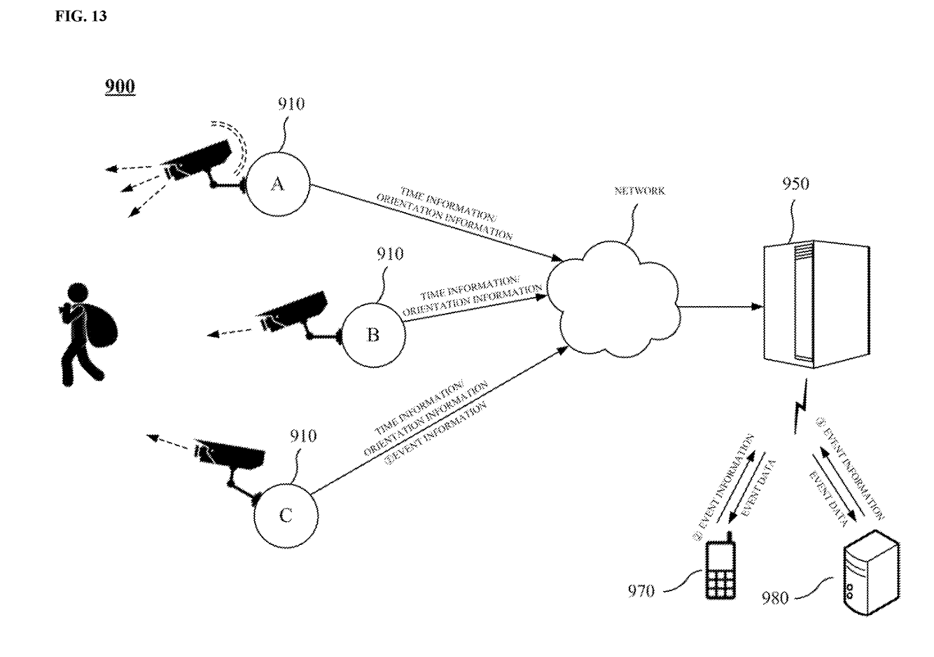

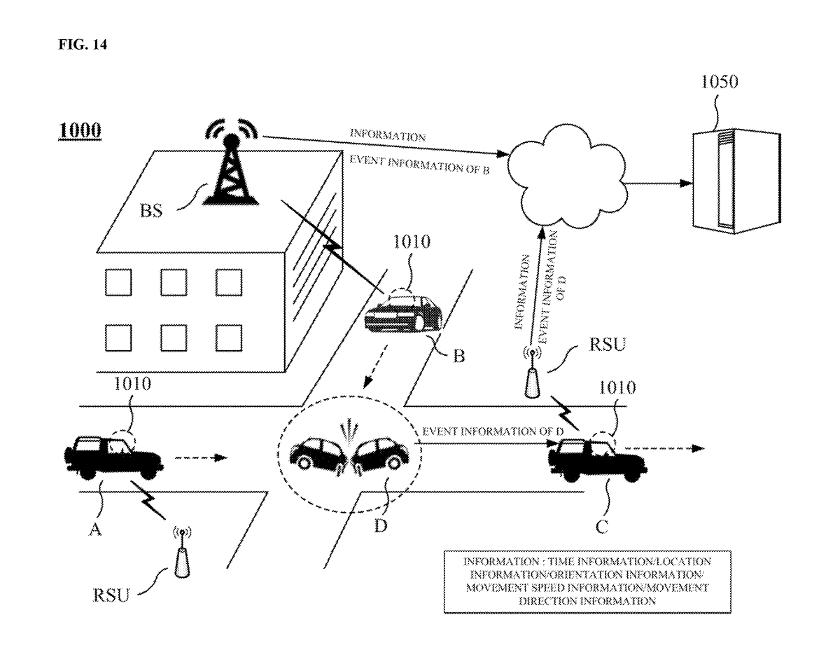

FIGS. 13 and 14 are exemplary embodiments of the system 200 for collecting event data illustrated in FIG. 2.

FIG. 13 is an example of a block diagram of a security system 900 for collecting event data. The security system 900 for collecting event data exemplifies a surveillance camera system installed in a building or on a street.

The security system 900 for collecting event data includes a plurality of cameras 910 which collect and store image data in storage media, generate data identification information including time information, location information, and orientation information related to the image data, and transmit the data identification information via a wired or wireless network periodically or at a specific time point, and a server 950 which receives image data related to an event from a camera related to the event among the plurality of cameras using event information for specifying the event and the data identification information. A constitution of the cameras 910 may be the same as described with reference to FIG. 3.

The orientation information transmitted by the cameras 910 may include information, such as rotation directions, rotation speeds, or the like of the cameras. Further, the cameras 910 may additionally transmit information on distances from an object whose movement is detected using distance measurement sensors. In this case, the data identification information includes the distance information, the time information, the location information, and the orientation information.

The cameras 910 may generate the orientation information which indicates view directions of the cameras using at least one of gyro sensors, acceleration sensors, and magnetism sensors. Needless to say, the cameras 910 may generate the time information by using timers or receiving time information via the wired or wireless network, and may generate the location information by using location devices in some cases. For example, when the cameras 910 are installed in a moving object, location information should be generated. However, in the case of cameras whose locations or orientations are fixed, the location information or the orientation information of each of the cameras may be pre-stored and managed in the server 950. Therefore, location information or orientation information may not be additionally required. The location information and the orientation information of the cameras are used to specify a camera related to an event.

When the cameras are installed in moving objects, the data identification information may further include at least one of movement speed information of the moving object and movement direction information of the moving object. In this case, the server 950 may further use the movement speed information or the movement direction information to specify a camera related to the event.

Further, the cameras 910 may generate data identification information further including at least one of angle-of-view information thereof, performance information thereof, camera setting information of times at which the image data is collected, and illuminance information of the times at which the image data is collected. The camera setting information denotes information, such as international organization for standardization (ISO) values, shutter speeds, and the like. The illuminance information, the camera performance information, the camera setting information, or the like may be used to determine whether good quality image data (which makes it possible to identify a security state) exists in environments of time points at which the image data is collected. Such a determination may be made by the service server 950 or each of the cameras 910.

On the assumption that the service server 950 basically has information on fixed locations of the cameras 910, FIG. 13 shows an example in which each of the cameras 910 transmits the time information and the orientation information to the service server 950. In the case of a surveillance camera, a surveillance viewpoint may be generally changed using mechanical equipment. A camera A shows an example in which a viewpoint thereof is changed, and changed direction information is transmitted to the service server 950 with time information.

The cameras 910 may analyze sound data acquired using microphones, movement data acquired using motion sensors, temperature data acquired using temperature sensors, or image data, and may transmit event information including data identification information of an occurrence time point of an event to the service server 950 when it is determined that the event has occurred. In FIG. 13, a camera C shows an example of at least one of image data and sound data being analyzed and event information being transmitted to the service server 950 when it is determined that an intruder exists. Needless to say, a user terminal 970 may transfer event information for requesting image data of a specific time point and location to the service server 950. Also, a service requesting server 980 which provides a security service may transfer event information to the service server 950 and receive corresponding event data.

The service server 950 which receives the event information may collect event information using the methods illustrated with reference to FIGS. 4 to 6. Subsequently, the service server 950 may transmit collected event data or reconstructed event data to the user terminal 970 or the like.

FIG. 14 is an example of a block diagram of a smart car system 1000 for collecting event data.

The smart car system 1000 for collecting event data includes a plurality of cars 1010 which collect image data using cameras, store the image data in storage media, generate data identification information including at least one of time information, location information, orientation information of the cameras, movement speed information, and movement direction information related to the image data, and transmit the data identification information via a wireless network periodically or at a specific time point, and a service server 1050 which receives image data related to an event from a car related to the event among the plurality of cars using event information for specifying the event and the data identification information.

Like in the security system 900 for collecting event data illustrated in FIG. 13, the cars 1010 may generate data identification information further including at least one of angle-of-views of the cameras, performance information of the cameras, camera setting information of times at which the image data is collected, and illuminance information of times at which the image data is collected.

A device which collects the image data is a camera device, such as a black box or the like, attached to a car. Alternatively, a smart phone may be placed in a cradle in a vehicle to acquire the image data. In FIG. 14, a region at which a camera is disposed in each vehicle is indicated by a broken line in the form of a circle.

The wireless network may be at least one of a mobile communication network and a vehicle ad-hoc network (VANET). A type of network used in a method of collecting event data is not important. However, a car may generally use a VANET or a mobile communication network to transmit data. Needless to say, a network based on another scheme may be used. In FIG. 14, a car B shows an example in which information is transferred through a base station BS, which is a part of a mobile communication network system, and cars A and C show an example in which information is transferred through road side units (RSU), which are some components of a VANET.

The cars 1010 may analyze sound data acquired using microphones, movement data acquired using motion sensors, temperature data acquired using temperature sensors, or the image data, and may transmit event information including data identification information of an occurrence time point of an event to the service server 1050 when it is determined that the event has occurred.

For example, in FIG. 14, the car B may detect an event in front of the car B in which a vehicle has rear-ended another vehicle using the image data, the sound data, or the like, and may transmit event information including location information and time information to the service server 1050. Further, when a car D involved in the accident analyzes image data, sound data, vibration data, and the like collected thereby and determines that an accident has occurred, the car D may transmit event information including information on a time and a location at which the accident has occurred to the service server 1050. The car D may transfer the event information using the VANET through the car C.

When the event information or an event data request, which is not shown in the drawing, is received from another service server, the service server 1050 may specify a car 1010 which has collected information related to the corresponding event and collect event information from the car. The service server 1050 may collect event data using the methods illustrated with reference to FIGS. 4 to 6.

In FIG. 14, the car C is close to an accident spot at an occurrence time point of the event, which is the vehicle accident, but orientation information is not related to the event. Therefore, image data and the like collected by the car C may not be used.

The service server of FIG. 14 may be a server of an insurance company or a server of a service company which provides accident data to the insurance company. Finally, the insurance company may acquire information required to calculate an insurance rate, such as a vehicle accident, an exact account of the accident, and the like, using the provided event data. In this process, owners of the information collection devices 910 and 1010, which collect specific data, may determine whether to provide event data collected by the owners. The owner of the information collection device may receive a predetermined payment from the service company or may have a predetermined incentive from the insurance company by providing event data.

The aforementioned camera (information collection device) will be additionally described. The aforementioned camera may store information on a location or time at which the image data (image) is acquired together with the image data. The aforementioned camera generates and uses information on a direction of the acquired image, that is, an orientation, as data identification information.

Data identification information generated by the aforementioned camera may further includes at least one of location information of the camera, information on a time at which the image data is generated, angle-of-view information of the camera, performance information of the camera, camera setting information of the time at which the image data is collected, illuminance information of the time at which the image data is collected, movement direction information of the camera, movement speed information of the camera, rotation direction information of the camera, rotation speed information of the camera, and information on a distance between a specific object in the image and the camera.

The camera generates and maps data identification information including the orientation information and the like to the acquired image data, stores the mapped data identification information and the image data, and transmits only the data identification information to the server periodically or when the server requests data identification information.

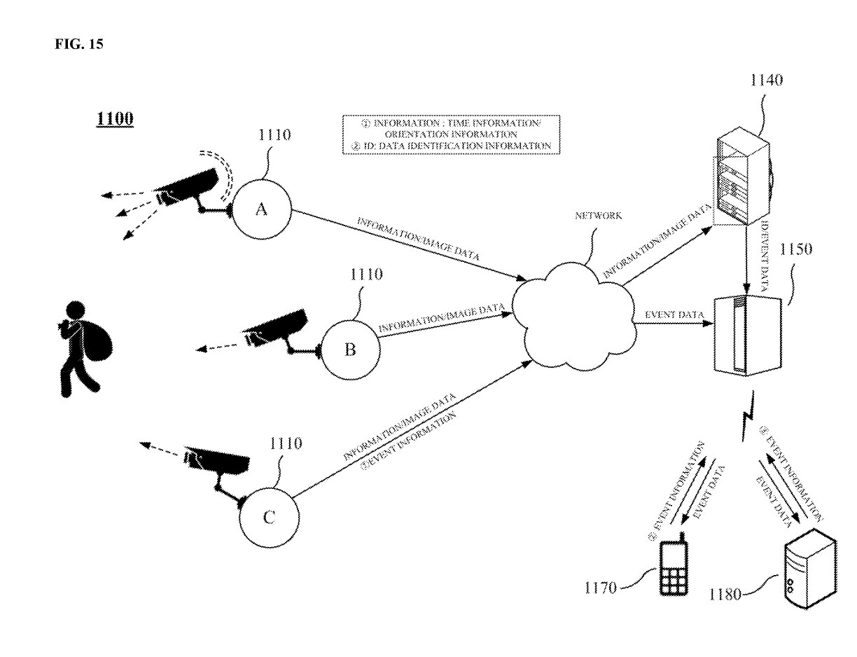

FIGS. 15 to 17 are exemplary embodiments of the system 200 for collecting event data illustrated in FIG. 8.

FIG. 15 is an example of a block diagram of a security system 1100 for collecting event data. The security system 1100 for collecting event data may be an example of a surveillance camera system installed in a building or on a street.

The security system 1100 for collecting event data includes a plurality of cameras 1110 which collect and store image data in storage media, generate data identification information including time information, location information, and orientation information related to the image data, and transmit the data identification information via a wired or wireless network, a management server 1140 which stores the data identification information transmitted by the plurality of cameras 1110, and a service server 1150 which receives event data from the plurality of cameras by using received event information. A constitution of the cameras 1110 may be the same as described with reference to FIG. 3. Meanwhile, the cameras 1110 may transmit the image data as well as the data identification information to the management server 1140, and the management server 1140 may store the image data.

The orientation information transmitted by the cameras 1110 may include information, such as rotation directions, rotation speeds, or the like of the cameras. Further, the cameras 1110 may additionally transmit information on a distance from an object whose movement is detected using a distance measurement sensor. In this case, the data identification information includes the distance information, the time information, the location information, and the orientation information.

The cameras 1110 may generate the orientation information which indicates view directions of the cameras using at least one of gyro sensors, acceleration sensors, and magnetism sensors. Needless to say, the cameras 1110 may generate the time information using timers or by receiving time information via the wired or wireless network, and may generate the location information using location devices in some cases. For example, when the cameras 1110 are installed in moving objects, location information should be generated. However, in the case of cameras whose locations or orientations are fixed, location information or orientation information of the cameras may be pre-stored and managed in the management server 1140. Therefore, location information or orientation information may not be additionally required. The location information and the orientation information of the cameras is used to specify a camera related to an event.

When the cameras are installed in moving objects, the data identification information may further include at least one of movement speed information of the moving object and movement direction information of the moving object. In this case, the service server 1150 may further use the movement speed information or the movement direction information to specify the camera related to the event.

Further, the cameras 1110 may generate data identification information further including at least one of angle-of-view information thereof, performance information thereof, camera setting information of times at which the image data is collected, and illuminance information of the times at which the image data is collected. The camera setting information denotes information, such as ISO values, shutter speeds, and the like. The illuminance information, the camera performance information, the camera setting information, or the like may be used to determine whether good quality image data (which makes it possible to identify a security state) exists in environments of time points at which the image data is collected. Such a determination may be made by the service server 1150 or each of the cameras 1110.

On the assumption that the service server 1150 basically has information on fixed locations of the cameras 1110, FIG. 15 shows an example in which each of the cameras 1110 transmits time information and orientation information to the management server 1140. In the case of a surveillance camera, a surveillance viewpoint may be generally changed using mechanical equipment. A camera A shows an example in which a viewpoint thereof is changed, and changed direction information is transmitted to the management server 1140 with time information.

The cameras 1110 may analyze sound data acquired using microphones, movement data acquired using motion sensors, temperature data acquired using temperature sensors, or image data, and may transmit event information including data identification information of an occurrence time point of an event to the service server 1150 when it is determined that the event has occurred. In FIG. 15, a camera C shows an example in which at least one of image data and sound data is analyzed and event information is transmitted to the service server 1150 when it is determined that an intruder exists. Needless to say, a user terminal 1170 may transfer event information for requesting image data of a specific time point and location to the service server 1150. Also, a service requesting server 1180 which provides a security service may transfer event information to the service server 1150 and receive corresponding event data.

While the management server 1140 manages only data identification information, the service server 1150 may collect event information using the methods illustrated with reference to FIGS. 9 and 10. While the management server 1140 manages data identification information and image data, the service server 1150 may collect event information using the methods illustrated with reference to FIGS. 11 and 12. Subsequently, the service server 1150 may transmit collected event data or reconstructed event data to the user terminal 1170 or the like.

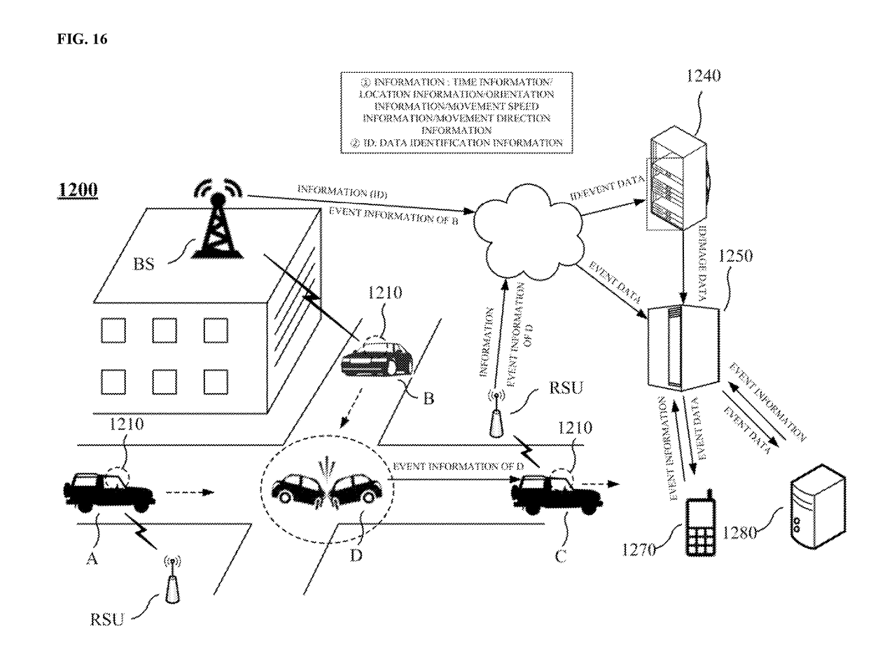

FIG. 16 is an example of a block diagram of a smart car system 1200 for collecting event data.

The smart car system 1200 for collecting event data includes a plurality of cars 1210 which collect image data using cameras, store the image data in storage media, generate data identification information including at least one of time information, location information, orientation information of the cameras, movement speed information, and movement direction information related to the image data, and transmit the data identification information via a wireless network periodically or at a specific time point, a management server 1240 which receives the data identification information from the plurality of cars 1210 and stores the received data identification information, and a service server 1250 which receives image data related to an event from a car related to the event on the basis of received event information. In this case, the service server 1250 receives the image data from the car 1210.

Meanwhile, the cars 1210 may transmit the collected image data as well as the data identification information to the management server 1240 via a wired or wireless network. In this case, the service server 1250 receives the image data from the management server 1240.

Like in the security system 700 for collecting event data illustrated in FIG. 15, the cars 1210 may generate data identification information further including at least one of angle-of-views of the cameras, performance information of the cameras, camera setting information of times at which the image data is collected, and illuminance information of the times at which the image data is collected.

A device which collects the image data is a camera device, such as a black box or the like, attached to a car. Alternatively, a smart phone may be placed in a cradle in a vehicle to acquire the image data. In FIG. 16, a region at which a camera is disposed in each vehicle is indicated by a broken line in the form of a circle.

The wireless network may be at least one of a mobile communication network and a VANET. A type of network used in a method of collecting event data is not important. However, a car may generally use a VANET or a mobile communication network to transmit data. Needless to say, a network based on another scheme may be used. In FIG. 16, a car B shows an example in which information is transmitted through a base station BS, which is a part of a mobile communication network system, and cars A and C show an example in which information is transmitted through RSUs, which are some components of a VANET.

The cars 1210 may analyze sound data acquired using microphones, movement data acquired using motion sensors, temperature data acquired using temperature sensors, or image data, and may transmit event information including data identification information of an occurrence time point of an event to the service server 1250 when it is determined that the event has occurred.

For example, in FIG. 16, the car B may detect an event in front of the car B in which a vehicle has rear-ended another vehicle using the image data, the sound data, or the like, and may transmit event information including location information and time information to the service server 1250. Further, when a car D involved in the accident analyzes image data, sound data, vibration data, and the like collected thereby and determines that an accident has occurred, the car D may transmit event information including information on a time and a location at which the accident has occurred to the service server 1250. The car D may transfer the event information using the VANET through the car C.

When an event data request message including event information is received, the service server 1250 transmits the event information to the management server 1240. A user terminal 1270 or a service requesting server 1280 may also transmit an event request message to the service server 1250. Subsequently, the service server 1250 may collect event data using the methods illustrated with reference to FIGS. 9 to 11.

In FIG. 16, the car C is close to an accident spot at an occurrence time point of the event, which is the vehicle accident, but orientation information is not related to the event. Therefore, image data and the like collected by the car C may not be used.

The service requesting server of FIG. 16 may be a server of an insurance company or a server of a service company which provides accident data to the insurance company. Finally, the insurance company may acquire information required to calculate an insurance rate, such as a vehicle accident, an exact account of the accident, and the like, using the provided event data.

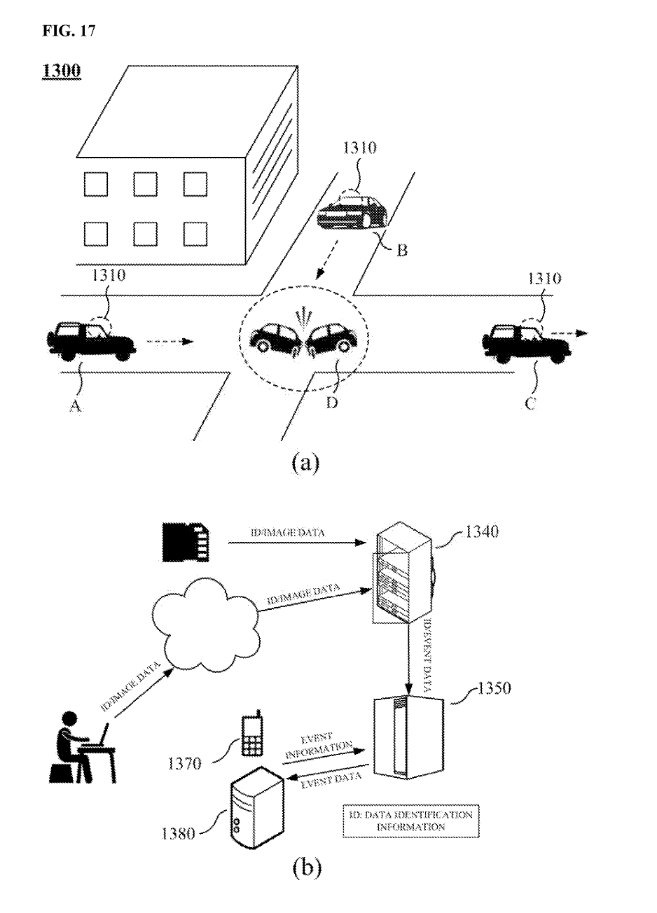

FIG. 17 is another example of transmitting data identification information and image data in the smart car system 1200 of FIG. 16.

FIG. 17(A) is an example showing operations of cars in a smart car system. Referring to FIG. 17(A), in a smart car system 1300, cars 1310 collect image data using cameras, store the image data in storage media, and generate data identification information including at least one of time information, location information, orientation information of the cameras, movement speed information, and movement direction information related to the image data. The cars 1310 store the data identification information and the image data collected by the cameras in memory devices. As the memory devices, a universal serial bus (USB) memory, a secure digital (SD) card, a memory card, a detachable hard disk drive, and the like may be used. Unlike FIG. 16, the cars 1310 do not transmit the data identification information or the image data to a management server 1340 via a wired or wireless network. In FIG. 17(A), the cars 1310 only stores the generated data identification information and the image data in the memory devices.

FIG. 17(B) is an example of a block diagram of the smart car system 1300 for collecting event data. A user separates the memory device from the car 1310 and transmits data identification information and image data stored in the memory device to the management server 1340. Referring to FIG. 17(B), the user may connect the memory device to his or her computer device and transmit the data identification information and the image data stored in the memory device to the management server 1340 via a wired or wireless network. Alternatively, the user may physically connect the memory device directly to the management server 1340 and transmit the data identification information and the image data stored in the memory device to the management server 1340.

A process of collecting event data thereafter is similar to FIGS. 11 and 12. Briefly, the data identification information and the image data are stored in the management server 1340, and the data identification information is transmitted to a service server 1350. The service server 1350 stores the data identification information. Subsequently, the service server 1350 receives an event data request from a service requesting server 1380 or a user terminal 1370 and determines the management server 1340 related to an event by comparing event data included in the event data request and the data identification information thereof. The service server 1350 requests event data from the determined management server 1340, and the management server 1340 determines event data on the basis of event information and the data identification information thereof. The management server 1340 transmits the event data to the service server 1350, and the service server 1350 transmits the event data to the device which has requested the event data.

FIG. 17 is another example of transmitting data identification information and image data in the smart car system 1300 of FIG. 16. However, the information collection device 210 of FIG. 8 or the camera 810 of FIG. 15 may store data identification information and image data, and then a user may transmit data identification information and image data stored in a memory device of the information collection device 210 or the camera 810 to the management server 240 or 840.

The present embodiment and the attached drawings are merely illustrative to describe a part of the technical spirit included in the above-described technology. Therefore, it should be apparent that modifications and specific embodiments which those or ordinary skill in the art can easily infer within the scope of the technical spirit included in the specification and drawings of the above-described technology fall within the technical scope of the above-described technology.

1. A system for collecting event data, the system comprising:
a plurality of cameras, each configured to collect and store image data in a storage medium, generate data identification information including at least one piece of information selected from the group consisting of information on a time at which the image data is collected, information on a location at which the image data is collected, and orientation information of the camera, and transmit the data identification information periodically or at a specific time point via a wired or wireless network; and
a service server configured to determine at least one target camera storing image data related to a specific event among the plurality of cameras using the data identification information and event information including a time at which the event has occurred and a location at which the event has occurred, and receive the image data related to the event from the target camera.

2. The system of claim 1, wherein the data identification information further includes at least one of information on a distance from an object related to the specific event, rotation direction information of the camera, rotation speed information of the camera, movement speed information of the camera, and movement direction information of the camera.

3. (canceled)

4. (canceled)

5. The system of claim 1, wherein the service server receives the event information from at least one of the plurality of cameras, a service requesting server at a remote place, or a user terminal.

6. The system of claim 1, wherein the event information further includes information on a direction in which the event has occurred.

7. The system of claim 1, wherein the data identification information further includes at least one of an angle-of-view of the camera, performance information of the camera, camera setting information of a time at which the image data is collected, and illuminance information of the time at which the image data is collected.

8. (canceled)

9. A system for collecting event data, the system comprising:
a plurality of information collection devices, each configured to collect and store data in a storage medium, generate data identification information including at least one piece of information selected from the group consisting of information on a time at which the data is collected, information on a locations at which the data is collected, and orientation information of the device collecting the data, and transmit the data identification information periodically or at a specific time point via a wired or wireless network; and
a service server configured to receive data related to a specific event from a target information collection device that is at least one information collection device storing the data related to the event among the plurality of information collection devices using the data identification information and event information including a time at which the event has occurred and a location at which the event has occurred.

10. The system of claim 9, wherein the data identification information further includes at least one of information on a distance from an object related to the specific event, rotation direction information of a camera, rotation speed information of the camera, movement speed information of the camera, and movement direction information of the camera.

11. (canceled)

12. (canceled)

13. The system of claim 9, wherein the event information further includes information on a direction in which the event has occurred.

14. The system of claim 9, further comprising:
a management server configured to store the data identification information transmitted by the plurality of information collection devices.

15. The system of claim 14, wherein the management server receives the event information and specifies the target information collection device by comparing the event information and the data identification information.

16. The system of claim 15, wherein the management server requests the related data from the target information collection device, and
the target information collection device transmits the related data to the service server.

17. The system of claim 9, wherein the service server determines the target information collection device by comparing the event information and the data identification information and requests the related data from the target information collection device.

18. A method of collecting event data, the method comprising:
storing, by a service server, a plurality of data identification information transmitted from a plurality of information collection devices;
receiving, by the service server, event information including a time at which a specific event has occurred and a location at which the event has occurred;
determining, by the service server, a target information collection device that is at least one information collection device storing image data related to the event among the plurality of information collection devices by comparing the event information and the data identification information, and transferring event identification information to the target information collection device; and
transmitting, by the target information collection device, event data, which is image data related to the event information, to the service server using the event identification information.

19. The method of claim 18, wherein the data identification information further includes at least one of information on a distance from an object related to the specific event, rotation direction information of the camera, rotation speed information of the camera, movement speed information of the camera and movement direction information of the camera.

20. (canceled)

21. The method of claim 18, wherein the receiving of the event information comprises receiving, by the service server, the event information from at least one of the plurality of information collection devices, a service requesting server at a remote place, or a user terminal.

22. The method of claim 18, wherein the information collection devices further collect at least one of sound data, smell data, vibration data, temperature data, humidity data, illuminance data, wind speed data, and wind direction data, and
the event data further includes at least one of the collected sound data, smell data, vibration data, temperature data, humidity data, illuminance data, wind speed data, and wind direction data.

23. The method of claim 18, further comprising determining, by the service server, a sequence or interrelation of at least one piece of event data received from at least one of the plurality of information collection devices according to at least one of a time and a location based on data identification information of the at least one piece of event data.

24. The method of claim 18, wherein the event identification information includes at least one of the event information and an identifier (ID) for specifying data stored in the target information collection device.

25. The method of claim 18, further comprising:
storing, by a management server, the data identification information received from the plurality of information collection devices; and
receiving, by the service server, the data identification information from the management server.

26. (canceled)

27. (canceled)

28. (canceled)

29. (canceled)

30. (canceled)

31. A method of collecting event data, the method comprising:
storing, by at least one management server, data identification information and image data from a plurality of information collection devices;
determining, by a service server, a target management server that is a management server storing image data related to a specific event among the at least one management server by comparing the data identification information and event information including a time at which the event has occurred and a location at which the event has occurred, and transferring event identification information to the target management server; and
receiving, by the service server, the event data, which includes image data related to the event information, from the target management server,
wherein the image data is generated by each of a plurality of information collection devices using a camera,
wherein the data identification information are generated by each of a plurality of information collection devices, and
wherein the data identification information includes at least one piece of information selected from the group consisting of information on a time at which the image data is collected, information on a location at which the image data is collected, and orientation information of the camera.

32. The method of claim 31, wherein the data identification information further includes at least one of information on a distance from an object related to the specific event, rotation direction information of the camera, rotation speed information of the camera, movement speed information of the camera, and movement direction information of the camera.

33. A method of collecting event data, the method comprising:
receiving, by a service server, event information including a time at which a specific event has occurred and a location at which the event has occurred;
broadcasting, by the service server, the event information; and
receiving, by the service server, image data related to the event information in response to the broadcast,
wherein the image data is determined by comparing the event information and the data identification information stored in the information collection devices,
wherein the image data is generated by each of a plurality of information collection devices using a camera,
wherein the data identification information are generated by each of a plurality of information collection devices, and
wherein the data identification information includes at least one piece of information selected from the group consisting of information on a time at which the image data is collected, information on a location at which the image data is collected, and orientation information of the camera.

34. The method of claim 33, wherein the data identification information further includes at least one of information on a distance from an object related to the specific event, rotation direction information of the camera, rotation speed information of the camera, movement speed information of the camera, and movement direction information of the camera.

35. The method of claim 33,
wherein the image data is determined by the information collection devices using the event information which receives from the service server and the data identification information stored in the information collection devices.

36. The method of claim 33, further comprising:
storing, by a management server, the data identification information received from the plurality of information collection devices;
comparing, by the management server, the event information and the data identification information stored in the management server and requesting the related image data from a target information collection device that is at least one information collection device storing the related image data among the plurality of information collection devices; and
transmitting, by the target information collection device, the related image data.

37. (canceled)

38. (canceled)

39. (canceled)

40. (canceled)

41. A camera wherein while image data of a predetermined time point is generated, data identification information including orientation information of the time point is generated, and
the generated image data and the data identification information are mapped to each other and stored.

42. The camera of claim 41, wherein the data identification information further includes at least one of information on a distance from a specific object, rotation direction information of the camera, rotation speed information of the camera, movement speed information of the camera, and movement direction information of the camera.
